(19) United States
(12) Patent Application Publication
(10) Pub. No.: US 2026/0008208 A1
(43) Pub. Date: Jan. 8, 2026

(54) HEAT TREATMENT OF 3D PRINTED PARTS

(71) Applicant: CYTIVA SWEDEN AB, Uppsala (SE)

(72) Inventors: Mikael Wineström, Uppsala (SE); Johan Alriksson, Uppsala (SE)

(21) Appl. No.: 19/111,873

(22) PCT Filed: Sep. 7, 2023
(86) PCT No.: PCT/EP2023/074595

§ 371 Date: Mar. 14, 2025

(30) Foreign Application Priority Data
Sep. 22, 2022 (GB) 2213862.2

(51) Int. Cl. B29C 35/04; B29C 35/08; B29C 35/16; B29C 59/02; B33Y 40/20; B33Y 80/00

(52) U.S. Cl. CPC B29C 35/041; B29C 35/0805; B29C 35/16; B29C 59/022; B29C 2035/0811; B29C 2035/1616; B33Y 40/20; B33Y 80/00

(57) ABSTRACT

The present disclosure relates to a method (1900) for surface treatment of 3D printed parts for bioprocessing equipment, the method comprising: applying (1902) pressure to a surface (210) to be treated of a 3D printed part (200) using a contact surface (111) of an elastomeric resurfacing tool (110); heating (1904) the contact surface (111) to a temperature above the melting temperature of a material of the 3D printed part (200), thereby melting the surface (210) to form a molten layer of the material at the surface (210); allowing (1906) the surface (210) to cool such that the molten layer formed at the surface (210) re-solidifies, thereby producing a treated surface; and withdrawing (1908) the pressure applied to the treated surface.

### FIELD

The present invention relates generally to post-processing of 3D printed parts for bioprocessing equipment. More particularly, the present invention relates to an apparatus and a method for surface treatment of a 3D printed part using heat, to improve the surface finish of said 3D printed part.

### BACKGROUND

3D printing technology also referred to as additive manufacturing has been in existence since the 1980's when it was primarily used for rapid prototyping for product development within certain industries. However, it is only in the last decade or so that the true potential of this technology has been realized. At present, 3D printing technology is being used in different technical fields for manufacturing a multitude of objects, ranging from household items, toys, clothes, tools, mechanical and industrial components, human tissues and many more.

3D printing technology offers increased design freedom and allows higher dimensional control over conventional manufacturing techniques like injection moulding and die casting, making it possible to manufacture highly complex structures with accuracy and repeatability.

Two widely used 3D printing technologies are fused deposition modelling (FDM) and selective laser sintering (SLS). In FDM technology, a thermoplastic filament is heated to its melting point and then extruded, layer by layer on a build platform to create a three-dimensional object. SLS on the other hand is a powder-based manufacturing technique where a laser beam is used to selectively melt the particles of a thermoplastic polymer powder placed on a powder bed, causing them to fuse together and build a part layer-by-layer.

One problem commonly associated with most 3D printed objects is that they usually have rough surfaces and thus need some form of post-processing to achieve the required surface finish. Objects printed using the FDM technology typically show prominent stair-stepping effect where layer marks are distinctly visible. One solution to overcome this problem is to reduce the layer heights, but this significantly increases the build time. Longer printing times can cause warping and filament jams. Similarly, objects printed using the SLS technology suffer from the problem of partially melted powder particles sticking to the surface, thus making the surface grainy.

The problem of poor surface finish of 3D printed parts has made the adoption of 3D printing technology difficult particularly in the manufacturing of parts for bioprocessing equipment. Poor surface finish is especially problematic if said bioprocessing equipment parts are joining parts or intended for use with wetted components where they need to provide adequate sealing function as well. Such parts include but are not limited to, for example, connectors, valves and adaptors that are used to interconnect various components such as chromatography columns, filtration units, dispensing units and tubing in a bioprocessing system. Poor surface finish can also offer a foothold for bacteria, dirt and other biological material within the bioprocessing equipment parts, which can lead to the development of biofilms within the bioprocessing equipment. The development of biofilms results in a requirement for increased cleaning of the bioprocessing equipment, reducing operational efficiency.

In addition, poor surface finish results, in general, in increased difficulty of cleaning bioprocessing equipment. For example, mechanical aids may be required in order to clean the bioprocessing equipment, as a result of adherence of biological matter and other substances to the equipment surfaces.

Some of the known post-processing methods include tumbling, water-jetting, sanding, chemical soak and rinse, coating, polishing and bead blasting. The amount of post-processing required depends on several factors including but not limited to the size of the part, the intended application and the type of 3D printing technology used for production.

Some methods of post-processing involve the application of heat, such as ironing, heated isostatic pressing (HIP) and hot gunning. Ironing involves depositing a thin layer of a thermoplastic polymer filament on the surface to be smoothened. However, this process is quite time-consuming and thus adds significantly to the overall build time without resulting in a very good surface finish. Using a hot gun or a flame torch to melt the rough surface is another known heat based post-processing method that is typically used by amateurs and hobbyists. However, this method produces highly uneven melting at the surface being treated resulting in shape distortion or melting away of thin and delicate sections if the operator is not careful enough. Also, as this method uses naked flame, it presents serious safety concerns.

The above-mentioned post-processing methods although considered satisfactory in some applications, are unable to provide the desired degree of surface finish to 3D printed parts used in bioprocessing equipment. The inadequate surface finish achieved using one or more of the above methods may result in surfaces which are not suitable as sealing surfaces in a bioprocessing system thereby making said system prone to leakage. Fluid leakages are highly undesirable in a bioprocessing facility as not only does it lead to loss of valuable biological products such as antibodies and other cell therapy products but could also cause contamination of the surrounding environment in case the biological product is a virus containing solution or the like.

Another problem that may arise is increased turbulence within the bioprocessing system, as a result of surface friction resulting from inadequate surface finish. Such increased turbulence could be damaging to sensitive cell-based products being handled in said system as well to the surrounding bioprocessing equipment.

There, is thus a need for an apparatus and a method for providing superior surface finish to 3D printed parts to make them suitable for bioprocessing equipment.

Hence the present invention, as defined by the appended claims, is provided.

### SUMMARY

This summary introduces concepts that are described in more detail in the detailed description. It should not be used to identify essential features of the claimed subject matter, nor to limit the scope of the claimed subject matter.

According to a first aspect of the present disclosure, there is provided a method for surface treatment of 3D printed parts for bioprocessing equipment, the method comprising: applying pressure to a surface to be treated of a 3D printed part using a contact surface of an elastomeric resurfacing tool; heating the contact surface to a temperature above the melting temperature of a material of the 3D printed part, thereby melting the surface to form a molten layer of the material at the surface; allowing the surface to cool such that the molten layer formed at the surface re-solidifies, thereby producing a treated surface; and withdrawing the pressure applied to the treated surface.

Using an elastomeric resurfacing tool to treat a surface of a 3D printed part results in a good surface finish, because the surface finish of the contact surface of the resurfacing tool can be transferred to the surface of the 3D printed part. Therefore, an elastomeric resurfacing tool can be provided with a contact surface having a high gloss finish, which is transferred to the surface of the 3D printed part during surface treatment in order to provide a treated surface with low surface roughness.

The elastomeric property of the resurfacing tool allows the contact surface to adapt to tolerance deviations in the surface to be treated. This means that the contact surface can be better aligned with the surface to be treated than, for example, a resurfacing tool formed of a rigid material such as metal.

In addition, the elastomeric property of the resurfacing tool allows complex surfaces to be treated, because the contact surface of the resurfacing tool can adapt to a surface with high complexity. This can be achieved, for example, by applying pressure to the contact surface of the resurfacing tool in order to deform the contact surface into contact with the complex surface.

Moreover, the elastomeric property of the resurfacing tool allows for treatment of surfaces that cannot be accessed by rigid resurfacing tools. In particular, an elastomeric resurfacing tool can be used to treat a surface that is not wholly accessible in a linear motion. Such a surface may include, for example, an interior surface of a part having an aperture, where the aperture is smaller than an interior cross-section of the part. Another example includes a surface that cannot be accessed via an aperture in a part owing to the presence of a bend between the surface and the aperture. To treat such a surface, the elastomeric resurfacing tool may be inserted through the aperture, whereupon pressure may be applied to deform the contact surface into contact with the surface to be treated.

Further, a resurfacing tool formed of an elastomeric material such as silicone has high heat resistance and is compatible with oils (which may be used to apply heat and/or pressure to the contact surface of the resurfacing tool), resulting in a long life expectancy of the resurfacing tool. A resurfacing tool formed of an elastomeric material such as silicone can be manufactured inexpensively and easily, and provide a surface finish at least as good as that achieved using metal surface processing tools.

In addition, the surface roughness of a 3D printed part can be significantly reduced in a repeatable manner at one or more locations.

According to a second aspect of the present disclosure, there is provided an apparatus for surface treatment of 3D printed parts for bioprocessing equipment, the apparatus comprising: an elastomeric resurfacing tool comprising a contact surface, wherein the contact surface comprises a negative shape of a surface to be treated of a 3D printed part; a pressure source configured to apply pressure to the surface using the contact surface; and a heat source configured to apply heat to the contact surface.

According to a third aspect of the present disclosure, there is provided a 3D printed part for bioprocessing equipment, comprising at least a partial surface portion thereof having a mean surface roughness value Ra (μm) that is: less than about 16 μm; less than about 15, 14, 13, 12, 11, 10, 9, 8, 7, 6, 5, 4, 3, 2.4, 2, 1.6, 1.5, 1, 0.9, 0.8, 0.7, 0.6, 0.5 or 0.4 μm; about 0.4 μm; from about 0.2, 0.3, 0.4, 0.5 or 0.6 μm to about 0.3, 0.4, 0.5, 0.6, 0.7, 0.8 or 0.9 μm; from about 0.2 or 0.3 to about 0.4 μm; and/or in the range from about 0.1, 0.2, 0.3, 0.4, 0.5, 0.6, 0.7, 0.8 or 0.9 μm to about 15, 14, 13, 12, 11, 10, 9, 8, 7, 6, 5, 4, 3, 2.4, 2, 1.6, 1.5, 1, 0.9, 0.8, 0.7, 0.6, 0.5 or 0.4 μm.

The partial surface portion of the 3D printed part has significantly reduced surface roughness compared to an untreated surface of the 3D printed part. Accordingly, 3D printed parts can be made without compromising on their sealing capability, making them suitable for bioprocessing equipment in aseptic environments where sealing is essential and critical. 3D printed parts processed using the methods and apparatus described herein are also highly suitable for use with wetted components in a bioprocessing facility owing to their superior sealing surfaces, which make them leak resistant. The reduced surface roughness of the partial surface portion also reduces the likelihood of biofilm development within the bioprocessing equipment, and reduces the turbulence within the bioprocessing equipment, thereby reducing the likelihood of damaging sensitive cell-based products handled within the bioprocessing facility.

### BRIEF DESCRIPTION OF FIGURES

Specific embodiments are described below by way of example only and with reference to the accompanying drawings, in which:

FIG. 1 shows a flowchart illustrating a method for surface treatment of a 3D printed part in accordance with the present invention.

FIG. 2A shows a perspective cross-sectional view of a first apparatus and a first part comprising a surface to be treated by a resurfacing tool of the first apparatus.

FIG. 2B shows a front cross-sectional view of the first apparatus and the first part shown in FIG. 2A.

FIG. 2C shows a front cross-sectional view of the first apparatus, in which inflatable portions of the resurfacing tool are shown in an inflated position.

FIG. 3A shows a perspective cross-sectional view of a second apparatus comprising the resurfacing tool shown in FIG. 2A and an alternative heat source, and the first part shown in FIG. 2A.

FIG. 3B shows a front cross-sectional view of the second apparatus and the first part shown in FIG. 3A.

FIG. 3C shows a front cross-sectional view of the second apparatus, in which inflatable portions of the resurfacing tool are shown in an inflated position.

FIG. 4A shows a cross-sectional side view of a third apparatus and a second part comprising a surface to be treated by a resurfacing tool of the third apparatus.

FIG. 4B shows a cross-sectional end view of the resurfacing tool and the second part shown in FIG. 4A.

FIG. 5 shows a cross-sectional view of a fourth apparatus and a third part comprising a surface to be treated by a resurfacing tool of the fourth apparatus.

FIG. 6 shows a close-up cross-sectional view indicating the surfaces of the third part shown in FIG. 5.

FIG. 7 shows a cross-sectional view of the resurfacing tool and the third part shown in FIG. 5, in which an inflatable portion of the resurfacing tool is in an inflated position.

FIG. 8A shows a cross-sectional view of a resurfacing tool of a fifth apparatus, and a fourth part comprising a surface to be treated by the resurfacing tool of the fifth apparatus.

FIG. 8B is a schematic diagram showing components of the fifth apparatus.

FIG. 9A shows a perspective view of a resurfacing tool of a sixth apparatus, and a fifth part comprising a surface to be treated by the resurfacing tool of the sixth apparatus.

FIG. 9B shows a cross-sectional view through the resurfacing tool of the sixth apparatus, and the fifth part shown in FIG. 9A.

FIG. 10A shows a perspective view of a composite part comprising multiple 3D printed component parts.

FIG. 10B shows a cross-sectional view through the composite part shown in FIG. 10A.

FIG. 11 shows a partial cross-sectional view of components of a seventh apparatus, and a sixth part comprising a surface to be treated by a resurfacing tool of the seventh apparatus.

FIG. 12A shows a schematic perspective view of further components of the seventh apparatus.

FIG. 12B shows a partial cross-sectional view through components of the seventh apparatus.

FIG. 13 shows a cross-sectional view of a mould for production of the resurfacing tool of the seventh apparatus.

FIG. 14A shows a side view of a seventh part having a post-processed surface.

FIG. 14B shows a perspective view of an eighth apparatus for post-processing the seventh part shown in FIG. 14A.

FIG. 15 shows a perspective view of an alternative tool support of the seventh apparatus.

### DETAILED DESCRIPTION

Implementations of the present disclosure are explained below with particular reference to 3D printed parts used in bioprocessing systems. It will be appreciated, however, that the apparatuses and methods described herein may also be applied to other 3D printed parts, and that such apparatuses and methods have general applicability to the post-processing of 3D printed parts.

In general terms, an apparatus for surface treatment of a 3D printed part comprises an elastomeric resurfacing tool, a heat source, and a pressure source. The elastomeric resurfacing tool comprises a contact surface comprising a negative shape of the surface to be treated of a 3D printed part. The pressure source is configured to apply pressure to the surface to be treated using the contact surface. The heat source is configured to apply heat to the contact surface, thereby causing melting of the surface to form a molten layer of material at the surface. The surface is then allowed to cool, thereby causing the molten layer formed at the surface to re-solidify, producing a treated surface. In particular, the re-solidified molten layer conforms to the contact surface.

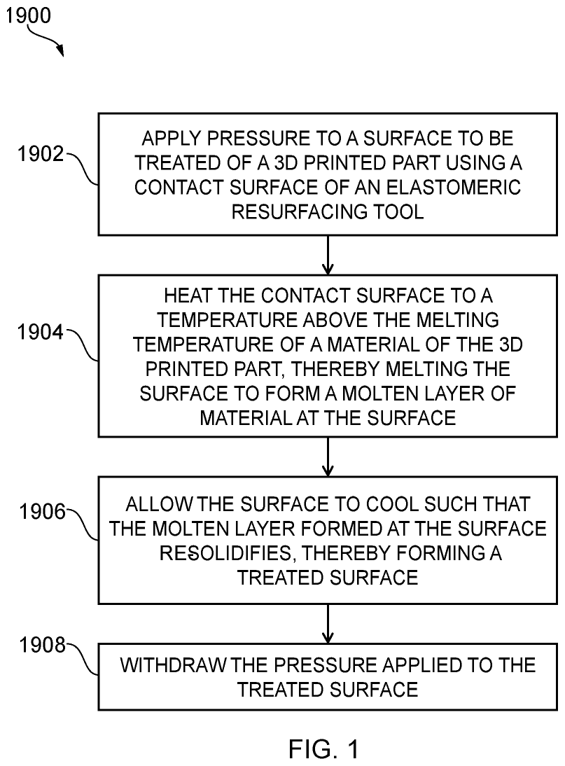

The process applied in order to treat a surface of a 3D printed part is generally described with reference to FIG. 1. The method 1900 of FIG. 1 may be implemented using the apparatus described above. In particular, the method 1900 may be implemented using the resurfacing tools of the apparatuses described below.

As shown, the method 1900 comprises a pressing step 1902, a heating step 1904, a cooling step 1906, and a withdrawal step 1908. For example, cooling may be provided to a temperature of about 70° C. (or lower).

The pressing step 1902 comprises applying pressure to the surface to be treated of the 3D printed part using an elastomeric (e.g. silicone) resurfacing tool having a contact surface that is the negative of the surface to be treated. The pressure is applied to the surface of the 3D printed part during the heating step 1904 and the cooling step 1906.

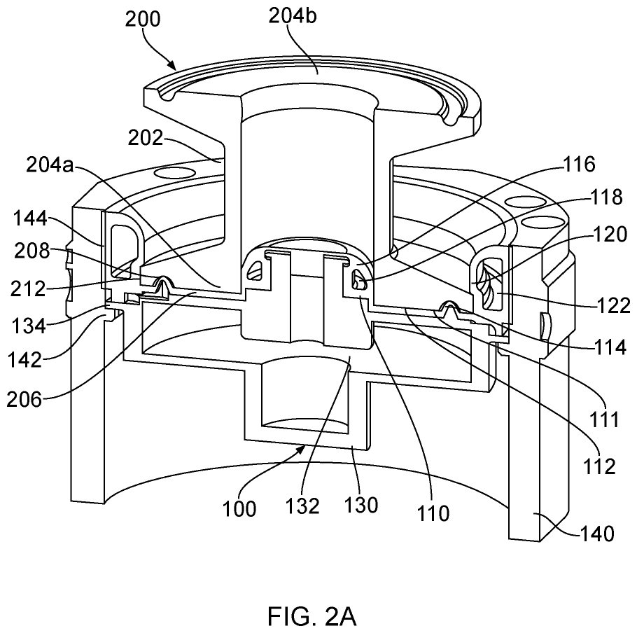

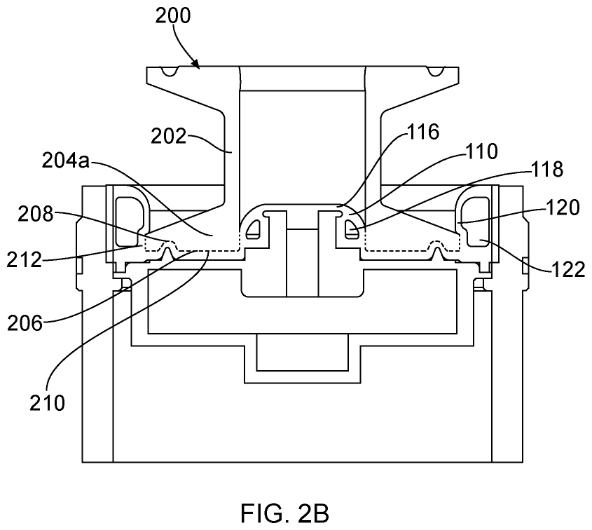

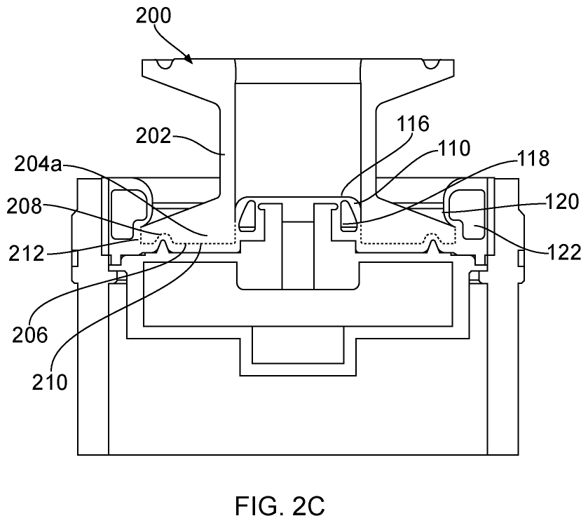

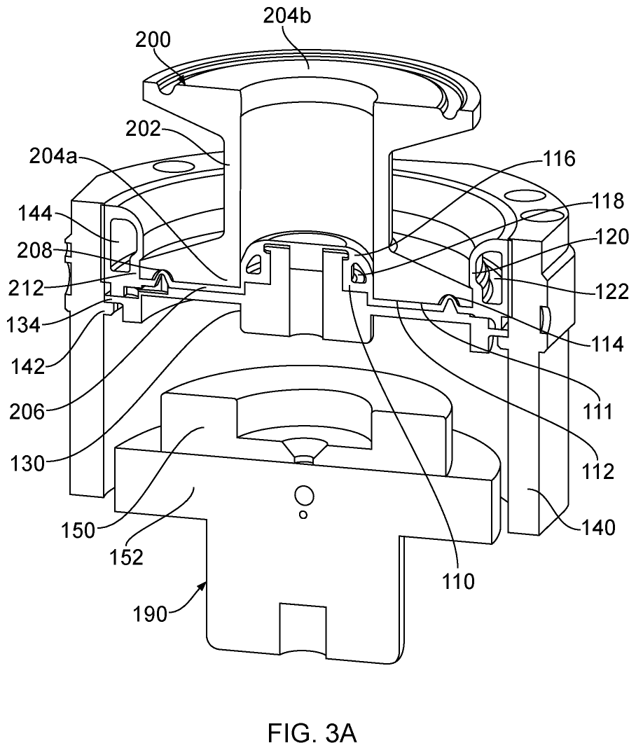

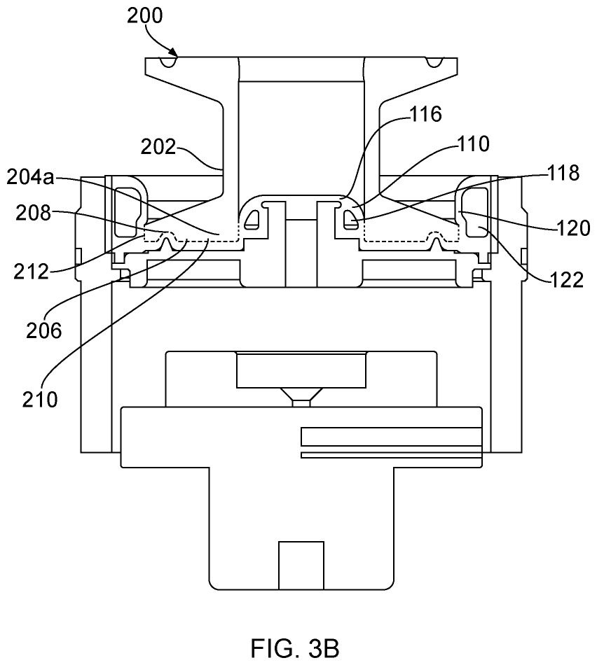

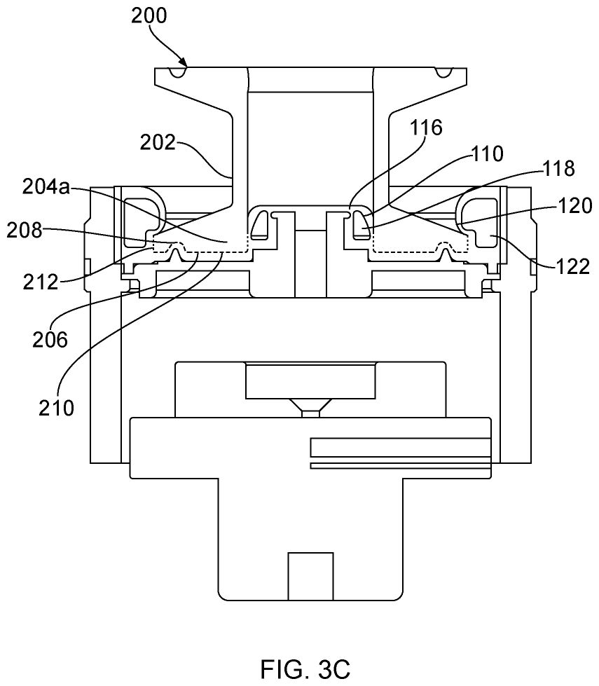

In some embodiments (e.g. the embodiments shown in FIGS. 2A to 7, 11 and 12), the pressure is applied mechanically, by clamping the contact surface of the resurfacing tool in contact with the surface to be treated. In certain embodiments (e.g. the embodiments shown in FIGS. 2A to 2C and 3A to 3C), mechanical pressure is applied by inflating inflatable portions of the resurfacing tool, thereby clamping the resurfacing tool to the part.

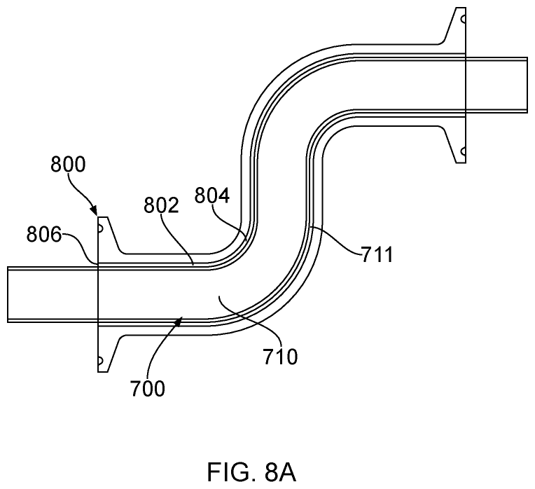

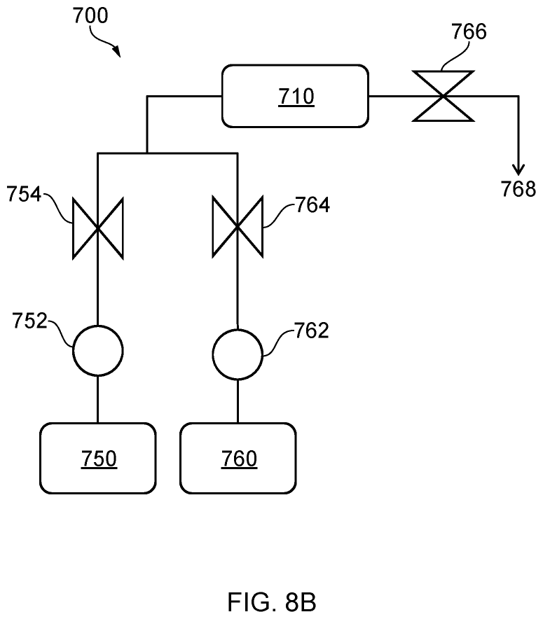

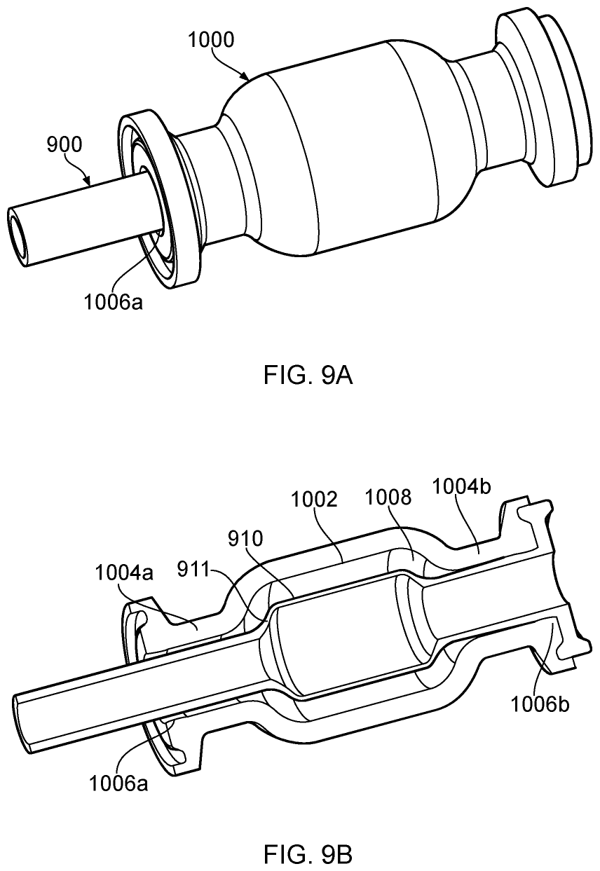

In alternative embodiments (e.g. the embodiments shown in FIGS. 8A, 8B and 9), or additionally, the pressure may be applied by the action of fluid within the resurfacing tool (e.g. by pressurising fluid within the resurfacing tool), which increases the pressure of fluid within resurfacing tool and causes the contact surface to apply pressure to the surface to be treated.

The applied pressure provides sealing areas between the resurfacing tool and the regions of the part that surround the surface to be treated. This prevents the flow of molten plastic from the surface to surrounding regions of the part that are not to be treated. The applied pressure may be in the region of 0.5 to 2 bar(g). In particular, for sensitive parts, the applied pressure may be in the region of 0.5 to 1 bar(g). For less sensitive parts, the applied pressure may be in the region of 1 to 2 bar(g).

The heating step 1904 comprises applying heat to the surface using the contact surface of the resurfacing tool. The heat applied at step 1904 may be applied simultaneously with the pressure applied at step 1902. The heat applied at step 1904 melts the surface to form a molten layer of material at the surface.

In some embodiments (e.g. the embodiments shown in FIGS. 3A to 7, 11 and 12), the heat is applied to the surface using a heating element. Heat from the heating element is transferred to the contact surface of the resurfacing tool.

In alternative embodiments (e.g. the embodiments shown in FIGS. 2A to 2C, 8A, 8B and 9), or additionally, the heat can be applied to the surface using a heated fluid within the resurfacing tool. Where fluid within the tool is also used to apply pressure to the surface at step 1902, the fluid used to apply pressure to the surface may be the same fluid that is heated at 1904 in order to transfer heat to the resurfacing tool. Alternatively, hot fluid may be pumped into a void or cavity within the resurfacing tool in order to displace the fluid used to deform the elastomeric material into contact with the surface, while maintaining pressure on the surface.

The temperature to which the resurfacing tool is heated depends on a material of the 3D printed part being treated. In general, the resurfacing tool is heated to a temperature above the melting point of the plastic material of the 3D printed part. Thus, for example, if the material is polypropylene (PP), the contact surface of the resurfacing tool could be heated to a temperature in the range of about 160° C. to 180° C. In another example, where the material is a PP adapted for 3D-printing, e.g. comprising a PP mixed with PE that has a melting temperature of about 125° C., the resurfacing tool may be heated to about 240° C. This is done so as to quickly melt the surface to a very low viscous state for the plastic to flow easily. The resurfacing tool may be heated to a temperature of no more than about 260° C., in order to prevent degradation of the silicone material of the resurfacing tool. In the embodiments described below, the resurfacing tool was formed of a silicone material with a Shore A value of between 15 and 40. Shore A values towards the upper end of this range were used for resurfacing tools used to treat surfaces with tight tolerances on dimensions (i.e. where re-shaping of the surface is to be avoided). Shore A values towards the lower end of this range were used for resurfacing tools with more relaxed tolerance requirements (i.e. where some re-shaping of the surface is permitted or desired). One example of a silicone material with Shore A values within this range is Elastosil(®) Vario available from Wacker Chemie AG of Munich, Germany. Any hardness value within the above range can be achieved by blending Elastosil(®) Vario 15 and Elastosil(®) Vario 40 in the appropriate quantities. For resurfacing tools formed of other silicones (or other elastomeric materials), the resurfacing tool may be heated to a different temperature (e.g. up to 300° C.).

Heating the resurfacing tool to a temperature that is significantly higher than the melting temperature of the material of the 3D printed part is advantageous because the material is melted while minimising deformation of the surrounding regions of the part (which may occur if the resurfacing tool were heated to a temperature closer to the melting temperature of the part material). Lower temperatures can, however, be used if the surrounding regions of the part (i.e. outside of the boundary of the surface that is to be heat treated) are actively cooled (e.g. using cooling channels within the resurfacing tool). However, heating the resurfacing tool to a temperature significantly higher than the melting temperature of the part material avoids the need for active cooling and allows passive cooling to be used to prevent melting of the sealing areas and surrounding part geometry. In this context, passive cooling refers to the use of thicker material in regions of the resurfacing tool that contact part surfaces that are not to be heat treated. The thicker material of the resurfacing tool in these regions extends the amount of time that it would take to melt the sealing areas and surrounding part geometry.

If the resurfacing tool cannot be heated to a temperature that is significantly higher than the melting temperature of the material of the 3D printed part (for example, to prevent degradation of the resurfacing tool), then the resurfacing tool can be heated for a longer period of time. In this case, active cooling of the surrounding regions of the part may be required. The need for active cooling of the surrounding regions will depend on the thermal conductivity of the material of the 3D printed part.

Lower temperatures can alternatively be used. For example, by using a resurfacing tool with a lower thickness and temperature sensors moulded into to the silicone material close to the contact surface, the surface can be heated to a lower temperature. For example, the resurfacing tool may be heated to a temperature between 150° C. and 260° C. (for example, between 150° C. and 175° C.) for between 90 and 180 seconds. The temperature to which the resurfacing tool is heated will depend on the mass of the part being treated, and how easily the heat can escape to the ambient environment. In one example, the temperature is preferably as low as possible without deforming the part.

In a first example, a small valve seat was treated by heating a contact surface of a resurfacing tool to a temperature of 150° C. for 110 seconds. In a second example, a large valve seat was treated by heating a contact surface of a resurfacing tool to a temperature of 175° C. for 180 seconds. In a third example, a TC-50 tri-clamp was treated by heating a contact surface of a resurfacing tool to a temperature of 170° C. for 140 seconds. In a fourth example, a TC-25 tri-clamp was treated by heating a contact surface of a resurfacing tool to a temperature of 155° C. for 90 seconds.

The heating step 1904 may comprise heating a first region of the resurfacing tool, without heating a second region of the resurfacing tool. For example, the first region of the resurfacing tool may comprise the contact surface, such that the heat applied to the surface by the contact surface of the resurfacing tool causes melting of the plastic material. The second region of the resurfacing tool may be adjacent to the first region and may contact a portion of the 3D printed part that is adjacent to the surface being treated. In this case, the temperature of the second region is insufficient to cause melting of the plastic material. This means that the second region provides a seal between the resurfacing tool and the 3D printed part, in order to confine plastic melted by the first region of the resurfacing tool to the surface being treated.

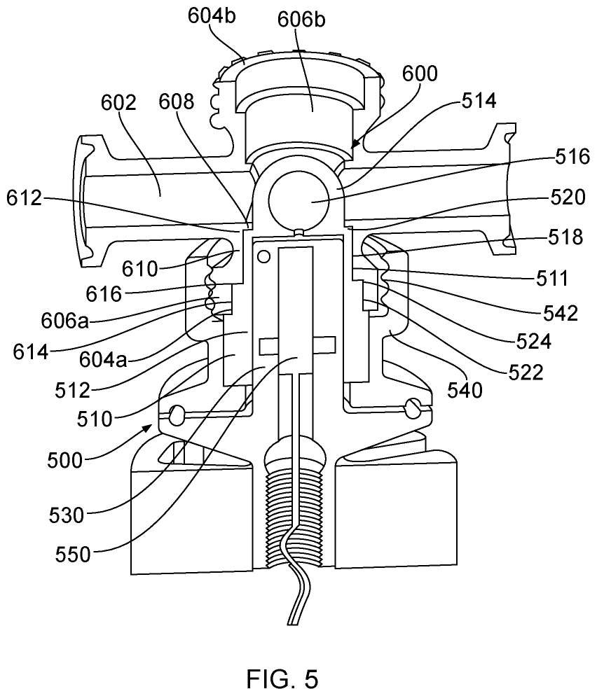

The cooling step 1906 comprises allowing the surface to cool, while maintaining pressure on the surface using the contact surface of the resurfacing tool. The surface is allowed to cool such that the molten layer formed at the surface re-solidifies, thereby forming a treated surface. In some embodiments (e.g. the embodiments shown in FIGS. 5-7, 12A and 12B), the surface is actively cooled by air cooling the resurfacing tool.

In alternative embodiments (e.g. the embodiments shown in FIGS. 2A to 2C, 8A, 8B and 9), the surface is actively cooled by cooling a fluid within the resurfacing tool. Where fluid within the resurfacing tool is also used to apply pressure to the surface at step 1902, the fluid used to apply pressure to the surface may be the same fluid that is cooled at 1906 in order to cool the resurfacing tool. Alternatively, cold fluid may be pumped into a void or cavity within the resurfacing tool in order to displace hot fluid used to apply heat to the surface.

In further alternative embodiments, the surface is passively cooled by stopping the application of heat to the contact surface of the resurfacing tool.

The withdrawal step 1908 comprises withdrawing the pressure applied by the resurfacing tool on the surface being treated. If pressure is applied mechanically at step 1902, then the mechanically applied pressure may be released at step 1908. Alternatively, if the pressure is applied at step 1902 by the action of fluid within the resurfacing tool, then the pressure applied to the fluid in order to pressurise the surface is reduced, meaning that the pressure applied to the surface is reduced. This means that the contact surface of the resurfacing tool can be withdrawn from contact with the surface being treated. The withdrawal step 1908 may further comprise applying a vacuum to the resurfacing tool in order to pull the contact surface of the resurfacing tool away from the treated surface.

FIG. 2A shows a cross-sectional view of a first apparatus 100 for surface treatment of a first 3D printed part 200. In the example shown in FIG. 2A, the 3D printed part 200 is a test piece comprising a tube with two tri-clamp flanges that are to be treated. The tri-clamp flanges shown in FIG. 2A are not limited to the specific test piece shown in FIG. 2A, and may be implemented in other tubes, valve blocks, manifold, or other bioprocessing equipment. The valve body comprises a cylindrical shaft 202 with a first flange 204a at one end and a second flange 204b at the opposite end. The flange 204a has an annular end surface 206, in which an annular groove 208 is formed.

The surface 210 that is to be treated is indicated by the dashed lines shown in FIGS. 2B and 2C. As shown in FIGS. 2B and 2C, the surface 210 that is to be treated includes the annular end surface 206 and the surfaces of the annular groove 208.

Returning to FIG. 2A, it can be seen that the apparatus 100 comprises a resurfacing tool 110. The resurfacing tool 110 is formed of an elastomeric material such as silicone (also known as polymerised siloxane) and may have a Shore A hardness value of between 15 and 40. The resurfacing tool 110 has a contact surface 111 that matches the surface 210 that is to be treated and may be shrink compensated if required. Specifically, the contact surface 111 comprises an annular surface 112 configured to contact the annular end surface 206 of the 3D printed part 200, and an annular protrusion 114 configured to contact the surfaces of the annular groove 208.

The resurfacing tool 110 further comprises a dome-shaped protrusion 116 configured to fit within the cylindrical shaft 202 of the 3D printed part such that the surface of the dome-shaped protrusion 116 contacts the interior surface of the cylindrical shaft 202 at the end of the cylindrical shaft 202 that is closest to the first flange 204a. The dome-shaped protrusion 116 comprises an annular internal channel 118 into which air (or another fluid) can be pumped via a port (not shown) in the resurfacing tool 110.

In addition, the resurfacing tool 110 comprises an annular lip 120 configured to fit over a rim 212 of the first flange 204a. The elastomeric property of the material of the resurfacing tool 110 allows the annular lip 120 to be urged over the rim 212. The annular lip 120 also comprises an annular internal channel 122 into which air (or another fluid) can be pumped via a port (not shown) in the resurfacing tool 110.

The apparatus 100 also comprises a tool support 130 (e.g. formed of a metal material) that supports the resurfacing tool 110 in order to maintain the contact surface 111 of the resurfacing tool 110 in contact with the surface 210 that is to be treated. The tool support 130 comprises an interior void 132 into which heated fluid and/or cooled fluid can be pumped via an inlet (not shown) to the interior void 132.

The tool support 130 and the resurfacing tool 110 are held within a cylindrical housing 140, which retains the tool support 130 in contact with the resurfacing tool 110. The cylindrical housing 140 comprises an annular lip 142 configured to support an annular rim 134 of the tool support 130. The cylindrical housing 140 also comprises an interior surface 144 configured to contact the surface of the annular lip 120 of the resurfacing tool 110. This means that the annular lip 120 of the resurfacing tool 110 is held between the rim 212 of the first flange 204a, and the interior surface 144 of the cylindrical housing 140.

The elastomeric property of the resurfacing tool 110 results in deformation of the resurfacing tool 110 when fluid is pumped into the annular internal channel 118 in the dome-shaped protrusion 116, and into the annular internal channel 122 in the annular lip 120. The inflated profiles of the annular internal channels 118, 122 are shown in FIG. 2C. Specifically, pumping fluid into the annular internal channel 122 in the annular lip 120 causes the annular lip 120 to expand radially inwards, thereby clamping the annular lip 120 over the rim 212 of the first flange 204a (as shown by the enlarged volume of the annular internal channel 122 in FIG. 2C). Pumping fluid into the annular internal channel 118 in the dome-shaped protrusion 116 causes the dome-shaped protrusion 116 to inflate, increasing the contact area between the surface of the dome-shaped protrusion 116 and the cylindrical shaft 202 (as shown by the enlarged volume of the annular internal channel 118 shown in FIG. 2C). Increasing the contact area between the surface of the dome-shaped protrusion 116 and the cylindrical shaft 202 helps to clamp the resurfacing tool 110 to the part 200.

As explained in more detail below, the resurfacing tool 110 is used to apply heat and pressure to the surface 210 that is to be treated, in order to melt the plastic material of the surface 210. The surface 210 is then cooled while pressure on the surface 210 is maintained. This causes the molten plastic to solidify. After cooling, the treated surface 210 will have a finish that corresponds to the contact surface 111 of the resurfacing tool 110. In other words, the contact surface 111 has the negative shape of the desired finish of the surface 210.

Advantageously, therefore, the contact surface 111 has a high gloss surface, as its surface finish is transferred to the surface 210 of the 3D printed part 200 that is to be treated. In order to provide the high gloss surface, the resurfacing tool 110 is machined to the exact dimensions of the surface to be treated and the contact surface 111 is processed to have a high surface finish. High surface finish of the contact surface 111 is required as the surface finish of the contact surface 111 is transferred to the surface to be treated when the resurfacing tool 111 is pressed against the surface to be treated. Thus, the surface finish of the contact surface 111 has a direct impact on the overall surface finish of the treated surface. In one or more embodiments, the mean surface roughness Ra value of at least part of the contact surface 111 of the resurfacing tool is preferably less than about 2 to about 2.4 μm. For example, a mean Ra value may preferably be less than 1 μm, in order to provide a surface finish of the surface 210 that is suitable for use as a sealing surface. More preferably, a mean Ra may be less than 0.4 μm, such as in the range of about 0.2-0.4 μm. The mould used to manufacture the resurfacing tool 110 may be formed of an acrylic polymer such as poly (methyl methacrylate) (PMMA), which can easily be polished to a high surface finish for transfer to the contact surface 111 of the resurfacing tool 110.

The surface finish of the contact surface 111 is transferred to the surface 210 of the 3D printed part 200. This means that, once treated, the 3D printed part 200 has a partial surface portion (i.e. the surface 210) with a mean Ra value that is preferably less than about 2 to about 2.4 μm, more preferably less than 1 μm, and more preferably less than 0.4 μm, such as in the range of about 0.2-0.4 μm. In addition, once treated, the 3D printed part comprises a surface treated layer, which is a depth of material that is behind the surface 210 and that has been melted by the applied heat. The surface treated layer may have a depth in the range of less than about 10, 15, 20, 30, 40 or 50 μm, from about 0.1-10.0 μm, in the range of about 4.0-9.0 μm and/or in the range of about 6.0-8.0 μm.

When the resurfacing tool 110 is in contact with the surface 210 that is to be treated, the resurfacing tool 110 is sealed against the part 200 in the regions indicated by the dotted lines in FIGS. 2B and 2C. These sealing regions prevent molten plastic from the surface 210 that is being treated from flowing to other portions of the part, thereby confining the molten plastic to the surface 210 that is being treated.

In the example shown in FIGS. 2A to 2C, heat is applied to the resurfacing tool 110 using heated fluid (e.g. heated oil) that is pumped into the interior void 132 of the tool support 130. The heat from the heated fluid is transferred to the contact surface 111 of the resurfacing tool 110 via the tool support 130. The heat from the heated fluid is transferred to the contact surface 111 because the portion of the tool support 130 that contacts the contact surface 111 of the resurfacing tool 110 has a thin wall. In turn, the walls of the resurfacing tool 110 are thin in the vicinity of the contact surface 111, thereby allowing the heat from the heated fluid to be transferred to the surface 210. The temperature to which the surface 210 is heated will depend on the material of the 3D printed part 200. In an example in which the 3D printed part 200 is formed of polypropylene, the surface 210 may be heated to about 240° C. This is done so as to quickly melt the surface 210 to a very low viscous state for the plastic to flow easily, so that the plastic flows easily over the surface 210.

The portions of the resurfacing tool 110 that contact regions of the part 200 that are not to be heat treated have thicker walls, so as to prevent heat transfer to such regions of the part 200 of sufficient magnitude to cause melting of those regions (e.g. to prevent melting of the sealing regions indicated by the dotted lines in FIGS. 2B and 2C). The portions of the tool support 130 that contact these portions of the resurfacing tool 110 may also have thicker walls, so as to reduce heat transfer to regions of the part 200 that are not to be heat treated. In addition, the resurfacing tool 110 may comprise cooling channels for air or liquid, in order to provide cooling of the portions of the resurfacing tool 110 that contact regions of the part 200 that are not to be heat treated.

In the example shown in FIGS. 2A to 2C, the pressure is applied to the surface 210 by inflation of the annular internal channels 118, 122 of the resurfacing tool 110. Specifically, the radially inward expansion of the annular internal channel 122 forces the annular end surface 206 and the annular groove 208 into contact with the contact surface 111 of the resurfacing tool 110. The inflation of the annular internal channels 118, 122 also helps the resurfacing tool 110 to form a seal against the annular rim 212 and the cylindrical shaft 202 of the part, in the sealing regions indicated by the dotted lines in FIGS. 2B and 2C.

Once the surface 210 has been melted by the application of heat using the resurfacing tool 110, the surface can be cooled using the resurfacing tool 110. During cooling, the pressure on the surface 210 is maintained, in order to prevent the resurfacing tool 110 from sticking to the molten plastic of the surface 210. The pressure on the surface 210 is maintained by maintaining the annular internal channels 118, 122 in their inflated state. A cooled fluid (e.g. cooled oil) is then pumped into the interior void 132 of the tool support 130 in order to displace the heated oil, providing gradual cooling of the surface 210. Once the surface 210 is fully cooled, the resurfacing tool 110 can be withdrawn from the surface 210. This is done by deflating the annular internal channels 118, 122 and removing the resurfacing tool 110 from within the cylindrical housing 140, thereby allowing the annular lip 120 to be deformed over the rim 212 of the part 200.

In one example, the fluid used to inflate the annular internal channels 118, 122 is a ferritic liquid gel (e.g. a ferrofluid or magnetorheological fluid) that is used to fill the annular internal channels 118, 122. The ferritic gel can then be magnetised, in order to retain the gel in position in the inflated annular internal channels 118, 122, thereby keeping the resurfacing tool 110 clamped against the part 200 so that pressure is applied to the surface 210.

FIG. 3A shows a cross-sectional view of a second apparatus 190, in which the resurfacing tool 110 in FIG. 2A is used with an alternative heating source. The surface 210 to be treated is shown schematically by the dashed lines in FIGS. 3B and 3C, while the sealing regions are shown schematically by the dotted lines in FIGS. 3B and 3C. In the example shown in FIGS. 3A to 3C, the resurfacing tool 110, part 200 and cylindrical housing 140 all have the same configuration as the corresponding elements in FIGS. 2A to 2C, and pressure is applied to the surface 210 in the same manner as described with reference to FIGS. 2A to 2C. However, in the example shown in FIGS. 3A to 3C, the tool support 130 does not have an interior void. Instead, the apparatus 190 comprises a heating element 150 and an actuator 152. The heating element 150 is brought into contact with the tool support 130 using the actuator 152. The heating element 150 has a toroidal shape.

To apply heat to the surface 210, the heating element 150 is activated and the actuator 152 is used to bring the heating element 150 into contact with the tool support 130, which conducts heat from the heating element 150 to the surface 210. As with the example shown in FIGS. 2A to 2C, the heat from the heating element 150 is transferred to the contact surface 111 as a result of the thin walls of the portion of the tool support 130 that is in contact with these components of the resurfacing tool 110. The thin walls of the resurfacing tool 110 in the vicinity of the contact surface 111 allow the heat transferred to these components to be transferred to the surface 210. The thicker walls of the tool support 130 and/or resurfacing tool 110 in other regions of the part 200 that are not to be heat treated prevents heat transfer to such other portions of the part 200 of sufficient magnitude to cause melting of those other portions. The surface 210 can then be cooled by using the actuator 152 to actuate the heating element 150 away from the surface 210 and/or by deactivating the heating element 150, so that heat is no longer applied to the surface 210, thereby allowing the surface 210 to cool. In addition, the surface 210 may subsequently be actively cooled by air cooling.

As a further alternative to the examples shown in FIGS. 2A to 3C, the resurfacing tool may comprise iron, so that heat can be applied to the surface of the 3D printed part by induction heating of the contact surface. The induction heating may be applied in combination with pressure applied mechanically, or by the action of fluid within the resurfacing tool.

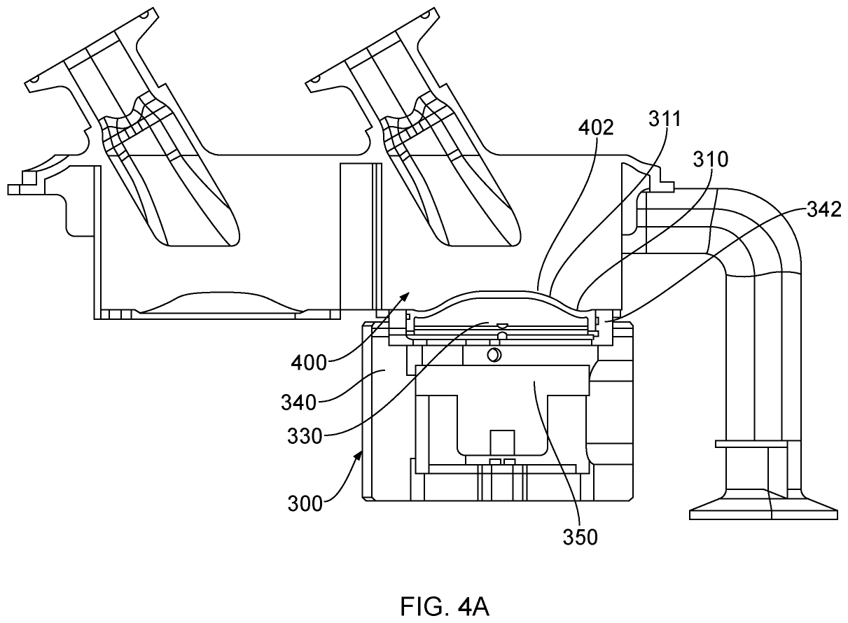

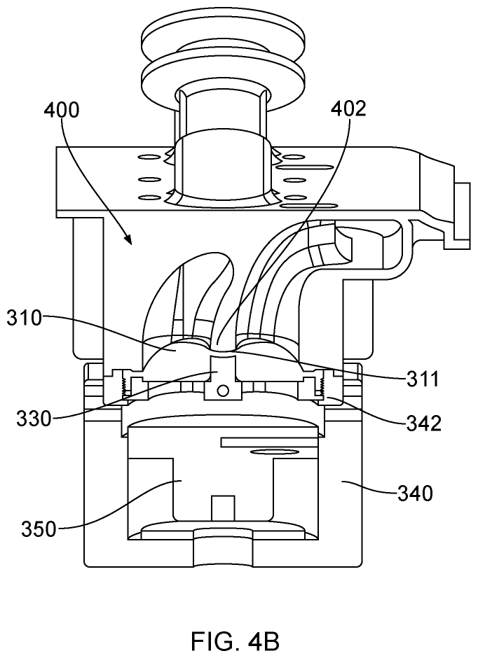

FIG. 4A shows a cross-sectional side view of a third apparatus 300 for surface treatment of a second 3D printed part 400, while FIG. 4B shows a cross-sectional end view through the apparatus 300 and the 3D printed part 400. In the example shown in FIGS. 4A and 4B, the 3D printed part 400 is a valve seat. The valve seat comprises a surface 402 that is to be treated.

As with the examples shown in FIGS. 2A to 3C, the apparatus 300 comprises an elastomeric (e.g. silicone) resurfacing tool 310 supported by a tool support 330 and held within a cylindrical housing 340. In this example, the cylindrical housing 340 comprises a clamp 342 that clamps the resurfacing tool 310 in place relative to the cylindrical housing 340. The tool support 330 is flexibly joined to the clamp 342 such that the tool support 330 can move relative to the clamp 342. The flexible join between the tool support 330 and the clamp 342 is achieved by filling the gap between the tool support 330 and the clamp 342 with silicone. The flexible coupling of the tool support 330 to the clamp 342 means that the resurfacing tool 310 is flexibly positioned within the clamp 342 and can conform to the surface 402 to be treated when a force is applied using an actuatable heating element 350 of the apparatus 300.

As shown in FIGS. 4A and 4B, the resurfacing tool 310 has a contact surface 311 that is the negative of the surface 402 of the part 400 (i.e. the valve seat surface). A hydraulic cylinder (not shown) is used to apply pressure to the surface 402 using the resurfacing tool 310. The pressure applied to the surface 402 by the hydraulic cylinder may be in the region of 1 to 2 bar(g) in order to clamp the resurfacing tool 310 to the surface 402. For more sensitive parts, an applied pressure in the region of 0.5 to 1 bar(g) may be used. An actuatable heating element 350 is used, once activated, to transfer heat to the tool support 330 and, in turn, the contact surface 311 of the resurfacing tool 310. The heat transferred to the contact surface 311 then melts the plastic of the surface 402. The surface 402 is then cooled, prior to releasing the pressure applied using the hydraulic cylinder and removing the apparatus 300 from the part 400.

As an alternative to the actuatable heating element 350 shown in FIGS. 4A and 4B and the hydraulic cylinder, a fluid may be used as both a heat transfer medium and a fluid transfer medium. For example, a fluid may be pumped into the cylindrical housing 340 in order to apply pressure to the surface 402. In this example, the pressure would be applied by the pressurised fluid acting on the flexibly mounted tool support 330, which in turn applies pressure to the resurfacing tool 310 and therefore to the surface 402. Heated fluid may then be pumped into the cylindrical housing 340 to displace the initial fluid, thereby transferring heat to the resurfacing tool 310 via the tool support 330 while maintaining the pressure applied to the surface 402 using the resurfacing tool 310. The surface 402 may then be allowed to cool by allowing the heated fluid within the cylindrical housing 340 to cool, or by pumping cooled fluid into the cylindrical housing 340 to displace the heated fluid.

FIG. 5 shows a cross-sectional view of a fourth apparatus 500 for surface treatment of a third 3D printed part 600. In the example shown in FIG. 5, the 3D printed part 600 replicates a design for a dual pressure sensor flow cell, where two pressure sensor locations are integrated into a conduit. As explained above, heat can be applied to the surface to be treated by a specific region of a resurfacing tool, while another region of the tool does not apply heat to the 3D printed part. The region that does not apply heat acts as a barrier to prevent the flow of molten plastic to areas of the 3D printed part that are not to be treated. For relatively simple geometries, the pressure applied to the surface by the resurfacing tool may be sufficient to seal the resurfacing tool against the 3D printed part in order to contain the molten plastic. However, for more complex geometries, a resurfacing tool with an inflatable seal can be used instead, such as the resurfacing tool 510 shown in FIG. 5.

In this example, the 3D printed part 600 comprises a conduit 602 comprising two oppositely disposed openings 604. A first opening 604a provides a fluidic connection between the conduit 602 and a lower port 606a, in which a first pressure sensor may be mounted. A second opening 604b provides a fluidic connection between the conduit 602 and an upper port 606b, in which a second pressure sensor may be mounted. The lower port 606a comprises a neck portion 608 at the join between the lower port 606a and the conduit 602. The lower port 606a further comprises a first cylindrical portion 610 having a cross-section that is larger than the neck portion 608. The first cylindrical portion 610 is joined to the neck portion 608 at a first shoulder 612. The lower port 606a further comprises a second cylindrical portion 614 having a cross-section that is larger than the cross-section of the first cylindrical portion 610. The second cylindrical portion 614 is joined to the first cylindrical portion 610 at a second shoulder 616.

In various embodiments, a lower-most port connector piece may be provided having respective inlet ports P1, used for oil, and P2, used for air. A pocket/recess may also be provided to house a temperature sensor that can be used for control purposes. The port connector piece also comprises respective outlet ports Q1 and Q2 from which air that flows into the port P2 can exit. As oil is pushed into the inlet port P1, an inflatable region of the silicone tool (e.g. a balloon), which can be prefilled with cool oil from the start, can be pressurized.

Additionally, a thin layer of oil may be added between the center piece (e.g. tool support 530) and the silicone tool 510. This thereby applies both a contact pressure as well as a sealing pressure. The heating element 550 in the center then provides heat which is conducted through the (e.g. metal) tool support 550 and the thin oil film to the silicone re-shaping tool 510. Once the heating element 550 is turned off, the apparatus 500 and oil may then be quickly cooled down by flowing of (e.g. compressed) air.

When a pressure sensor is mounted in the lower port 606a, an O-ring seal is also mounted in the lower port 606a and rests against the first shoulder 612 in order to prevent leakage of fluid through the lower port 606a. The second shoulder 616 defines a stop shoulder for the pressure sensor, which in turn defines the degree of compression of the O-ring seal resting against the first shoulder 612. Accordingly, the O-ring seal is compressed between the first shoulder 612, the first cylindrical portion 610, and the pressure sensor.

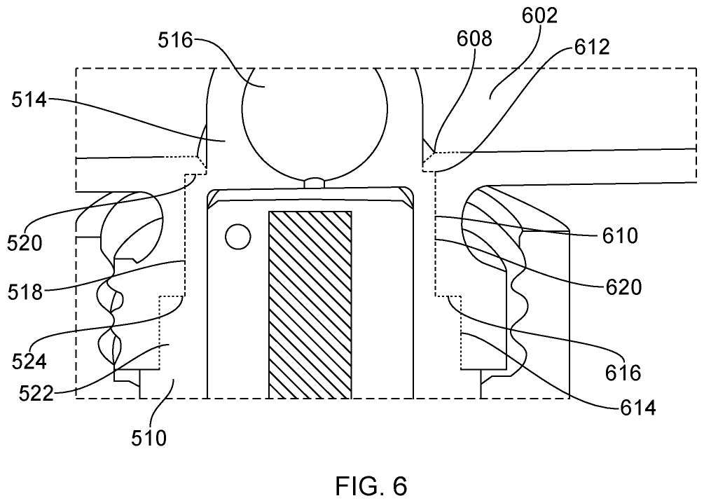

The surfaces 620 that are to be treated are indicated schematically in FIG. 6. Specifically, the first shoulder 612 and the first cylindrical portion 610 are to be heat treated, as indicated by the dashed lines in FIG. 6. These are the surfaces that are contacted by the O-ring seal. Treatment of the surfaces 620 is necessary in order to ensure sufficient sealing between the O-ring seal and the lower port 606a to prevent fluid leakage.

The apparatus 500 comprises an elastomeric (e.g. silicone) resurfacing tool 510. The resurfacing tool 510 is supported by a tool support 530 of the apparatus 500. The tool support 530 is disposed within a cylindrical cavity 512 of the resurfacing tool 510. The apparatus 500 further comprises a heating element 550 disposed within a cavity 532 of the tool support 530.

The apparatus 500 also comprises a housing 540 that holds the resurfacing tool 510 and the tool support 530. The housing 540 comprises an internal screw thread 542 that allows the housing 540 to be connected to the lower port 606a of the part 600 using a corresponding external screw thread on the exterior of the second cylindrical portion 614. The connection of the housing 540 to the lower port 606a applies pressure to the surfaces 620 via the resurfacing tool 510.

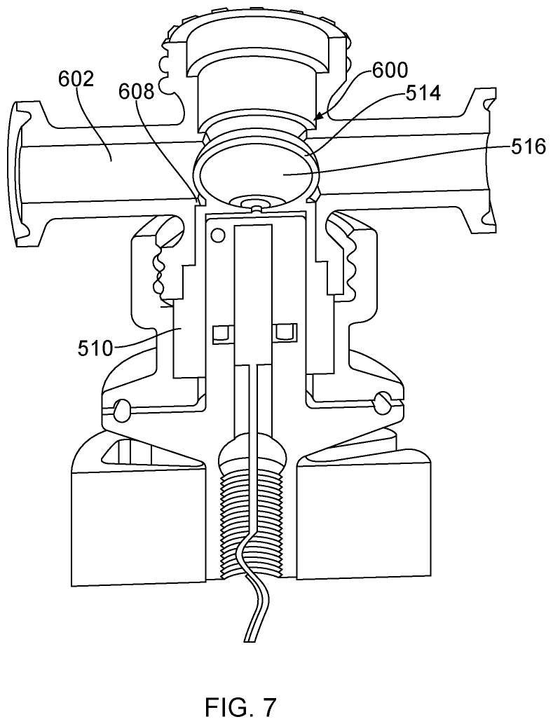

The resurfacing tool 510 comprises a domed end 514 configured to fit through the neck portion 608 of the part 600. The resurfacing tool 510 also includes an inflatable void 516 within the domed end 514, allowing the domed end 514 to be inflated from the configuration shown in FIG. 5 to the configuration shown in FIG. 7. In one example, fluid is pumped into the inflatable void 516 via conduits (not shown) in the tool support 530, in order to inflate the domed end 514. When the domed end 514 is in the inflated configuration shown in FIG. 7, the domed end 514 contacts the interior surfaces of the conduit 602, thereby preventing the flow of molten plastic from the surfaces of the lower port 606a to the interior surfaces of the conduit 602.

The resurfacing tool 510 further comprises a first cylindrical portion 518 having a cross-section that matches the cross-section of the first cylindrical portion 610 of the part 600, meaning that the first cylindrical portion 518 of the resurfacing tool 510 is the negative of the first cylindrical portion 610 of the part 600. The first cylindrical portion 518 of the resurfacing tool 510 is joined to the domed end 514 at a first shoulder 520, which is the negative of the first shoulder 612 of the part 600. The first cylindrical portion 518 and the first shoulder 520 form contact surfaces 511 of the resurfacing tool 510.

In addition, the resurfacing tool 510 comprises a second cylindrical portion 522 having a cross-section that matches the cross-section of the second cylindrical portion 614 of the part 600, meaning that the second cylindrical portion 522 of the resurfacing tool 510 is the negative of the second cylindrical portion 614 of the part 600. The second cylindrical portion 522 of the resurfacing tool 510 is joined to the first cylindrical portion 518 of the resurfacing tool 510 at a second shoulder 524, which is the negative of the second shoulder 616 of the part 600.

The resurfacing tool 510 is used to melt the surfaces 620 of the part 600 that are to be treated, while preventing the escape of molten plastic from the surfaces 620. In particular, the thicker walls of the second cylindrical portion 522 and the second shoulder 524 of the resurfacing tool 510 prevent melting of the second cylindrical portion 614 and the second shoulder 616 of the part 600, by reducing the heat transfer to the second cylindrical portion 614 and the second shoulder 616. By preventing melting of the second cylindrical portion 614 and the second shoulder 616, sealing regions are provided between the second cylindrical portion 522 of the resurfacing tool 510 and the second cylindrical portion 614 of the part 600, and between the second shoulder 524 of the resurfacing tool 510 and the second shoulder 616 of the part 600 (as indicated by the dotted lines in FIG. 6). These sealing regions prevent the flow of molten plastic from the surfaces 620 to the second shoulder 616 and the second cylindrical portion 614.

Likewise, the thicker walls at the base of the domed end 614 prevent melting of the neck portion 608 of the part 600, by reducing the heat transfer to the neck portion 608. By preventing melting of the neck portion 608, a sealing region is provided between the base of the domed end 514 of the resurfacing tool 510 and the neck portion 608 of the part 600. This sealing region prevents the flow of molten plastic from the surfaces 620 to the neck portion 608 (and into the conduit 602).

In this example, the sealing region between the neck portion 608 of the part 600 and the base of the domed end 514 is relatively short (e.g. compared with the sealing regions adjacent to the second cylindrical portion 614 and the second shoulder 616). Such a short sealing region increases the risk of molten plastic ingress into the conduit 602. Accordingly, additional sealing of the conduit 602 is provided by inflating the domed end 514 of the resurfacing tool 510. As mentioned above, the inflatable void 516 within the domed end 514 allows the domed end 514 to be inflated so that it contacts the interior surfaces of the conduit 602 (as shown in FIG. 7) and seals the conduit 602 from ingress of molten plastic.

In order to treat the surfaces 620, the resurfacing tool 510 is initially inserted into the lower port 606a so that the domed portion 514 protrudes through the first opening 504a. The resurfacing tool 510 is inserted until the first shoulder 520 of the resurfacing tool 510 abuts the first shoulder 612 of the part 600. In this position, the second shoulder 524 of the resurfacing tool 510 abuts the second shoulder 616 of the part 600. The resurfacing tool 510 is then connected to the lower port 606a using the screw thread 542, thereby causing pressure to be applied to the surfaces 620 via the contact surfaces 511 of the resurfacing tool 510.

The domed end 514 is then inflated by supplying a fluid, such as air or a cold liquid, to the inflatable void 516. For example, fluid may be pumped into the inflatable void 516 via conduits (not shown) in the tool support 530. Supplying fluid to the inflatable void 516 causes the domed end 514 to expand until it contacts the interior surfaces of the conduit 602, as shown in FIG. 7.

Heat is then applied by activating the heating element 550 disposed within the tool support 530. The tool support 530 conducts the heat from the heating element 550 to the contact surfaces 511 of the resurfacing tool 510. The resurfacing tool 510 transfers the heat to the surfaces 620 as a result of the thin walls of the contact surfaces 511 of the resurfacing tool 510. The heat applied to the surfaces causes the plastic to melt.

After the surfaces 620 have been melted, the molten plastic conforms to the contact surfaces 511 of the resurfacing tool 510, which transfers the high gloss surface of the contact surfaces 511 of the resurfacing tool 510 to the surfaces 620. The heat is then removed, and the resurfacing tool 510 is cooled. In one example, the heating element 550 is deactivated, and air is pumped into voids (not shown) within the tool support 530 in order to cool the tool support 530. Once the surfaces 620 have solidified after sufficient cooling, fluid can be removed from the inflatable void 516 in order to deflate the domed end 514 so that it returns to the configuration shown in FIG. 5, thereby allowing the domed end 514 to be removed through the first opening 604a. The resurfacing tool 510 can then be unclamped from the part 600 and removed from the lower port 606a.

In an alternative example, heat can be applied to the contact surfaces 511 of the resurfacing tool 510 using a heated fluid within the tool support 530. In such an example, the fluid path to the inflatable void 516 of the resurfacing tool 510 is separate to the fluid path for heated fluid to flow into the tool support 530, in order to ensure that heated fluid does not fill the inflatable void 516.

FIG. 8A shows a cross-sectional view of a fifth apparatus 700 comprising a further alternative elastomeric (e.g. silicone) resurfacing tool 710 having a contact surface 711 for surface treatment of a fourth 3D printed part 800. In its simplest form, the resurfacing tool 710 may be provided in the form of an elastomeric (e.g. silicone) tube that is cut to the appropriate length. In the example shown in FIG. 8A, no tool support is required in the apparatus 700, and heat and pressure are applied to the surfaces of the 3D printed part 800 using a heated fluid. FIG. 8B schematically illustrates further components of the apparatus 700.

As shown in FIG. 8A, the 3D printed part 800 comprises a conduit 802 having an interior surface 804 that is to be treated. The interior surface 804 is accessed via an aperture 806 at the end of the conduit 802. The conduit 802 curves through 90 degrees in a first direction before straightening and curving through 90 degrees in a second direction opposite to the first direction. Accordingly, at least a portion of the interior surface 804 of the conduit 802 cannot be accessed by insertion of a rigid (e.g. metal) tool through the aperture 806. In other words, the 3D printed part 800 includes one or more surfaces that are not simultaneously accessible in a linear motion (i.e. surfaces that cannot be illuminated with a parallel set of rays through the aperture 806).

The resurfacing tool 710 is provided in the form of a flexible tube. As shown in FIG. 8B, the resurfacing tool 710 is connected to a heated fluid source 750 by a first pump 752. The heated fluid source 750 may, for example, include a heating element configured to heat a fluid. A first valve 754 controls the flow of fluid from the first pump 752.

Similarly, the resurfacing tool 710 is connected to a coolant fluid source 760 by a second pump 762. A second valve 764 controls the flow of fluid from the second pump 762. A pressure control valve 766 is located at a fluid outlet from the resurfacing tool 710, and is used to control the pressure of fluid within the resurfacing tool 710. After passing through the pressure control valve 766, the fluid passes to a fluid return 768. The fluid return 768 may return used fluid to the heated fluid source 750 and/or the coolant fluid source 760.

In use, the resurfacing tool 710 is inserted into the 3D printed part 800. The flexible property of the resurfacing tool 710 allows the tool to be inserted through the curved sections of the conduit 802. Cold fluid from the coolant fluid source 760 is then pumped into the resurfacing tool 710 using the second pump 762. Pressure is applied to the cold fluid within the resurfacing tool 710 using the pressure control valve 766, in order to cause expansion of the resurfacing tool 710 so that the contact surface 711 of the resurfacing tool 710 applies pressure to the interior surface 804 of the part 800.

Hot fluid (e.g. between 150° C. and 250° C.) from the heated fluid source 750 is then pumped into the resurfacing tool 710 using the first pump 752, in order to displace the cold fluid. The pressure control valve 766 controls the pressure of the fluid within the resurfacing tool 710 during pumping of the hot fluid into the resurfacing tool 710, so that the pressure on the interior surface 804 is maintained. The resurfacing tool 710 conducts the heat from the hot fluid and transfers the heat to the interior surface 804 via the contact surface 711. This causes the interior surface 804 to melt to a surface with lower surface roughness (as a result of the high gloss finish of the contact surface 711 of the resurfacing tool 710).

After the interior surface 804 has melted, cold fluid from the coolant fluid source 760 is pumped into the resurfacing tool 710 using the second pump 762, in order to cool the interior surface 804 and cause it to re-solidify. The pressure control valve 766 controls the pressure of the fluid within the resurfacing tool 710 during pumping of the cold fluid into the resurfacing tool 710, so that the pressure on the interior surface 804 is maintained. Once the interior surface 804 has re-solidified, the pressure on the fluid within the resurfacing tool 710 is released by opening the pressure control valve 766, so that the pressure applied to the surface 804 is released and the resurfacing tool 710 can be withdrawn from the part 800.

Fluid may alternatively be supplied to the resurfacing tool 710 using one or more cylinders and/or pressure tank instead of the first pump 752 and/or the second pump 762.

FIG. 9A shows a perspective view of a sixth apparatus 900 comprising a further alternative elastomeric (e.g. silicone) resurfacing tool 910 having a contact surface 911 for heat treatment of a fifth 3D printed part 1000. FIG. 9B shows a cross-sectional view through the resurfacing tool 910 and part 1000 shown in FIG. 9A. In the example shown in FIGS. 9A and 9B, no tool support is required in the apparatus 900, and heat and pressure are applied to the surfaces of the 3D printed part 1000 using a heated fluid.

As shown in FIGS. 9A and 9B, the 3D printed part 1000 comprises a substantially cylindrical cavity 1002 having a first cross-sectional area. The part 1000 further comprises a first neck portion 1004a at one end of the cavity 1002, and a second neck portion 1004b at an opposite end of the cavity 1002. Each neck portion 1004 has a second cross-sectional area that is smaller than the first cross-sectional area, meaning that there is a negative draft angle between the interior surface of each neck portion 1004 and the interior surface of the cavity 1002. A first opening 1006a in the part 1000 leads to the first neck portion 1004a, while a second opening 1006b in the part 1000 leads to the second neck portion 1004b. The surfaces 1008 that are to be treated are the interior surfaces of the cavity 1002 and the neck portions 1004. These surfaces 1008 comprise negative draft surfaces. Accordingly, at least a portion of the surface 1006 of the part 1000 cannot be accessed by insertion of a rigid (e.g. metal) tool through the openings 1006. In other words, the 3D printed part 1000 includes one or more surfaces that are not simultaneously accessible in a linear motion (i.e. surfaces that cannot be illuminated with a parallel set of rays through the openings 1006).

In order to treat the surfaces 1008 of the 3D printed part 1000, the resurfacing tool 910 can have a profile that corresponds to the interior of the part 100, but is a shrunken version of the interior of the part 1000. Alternatively, a generic (e.g. cylindrical) resurfacing tool 910 may be used, which adapts to the interior surfaces of the part 1000 when pressurised.

In use, the resurfacing tool 910 is inserted into the 3D printed part 1000 through one of the openings 1006. The resurfacing tool 910 is then inflated using fluid, which deforms the resurfacing tool 910 and causes its contact surface 911 to apply pressure to the surfaces 1008 of the part 1000. The fluid used to inflate the resurfacing tool 910 is then replaced with hot fluid, while maintaining the pressure on the surfaces 1008. The resurfacing tool 910 transfers the heat from the hot fluid to the surfaces 1008 via the contact surface 911, causing the plastic to melt and conform to the contact surface 911 of the resurfacing tool 910. The hot fluid is then replaced with cold fluid, while maintaining the pressure on the surfaces 1008. The cold fluid cools the surfaces 1008, causing the molten plastic to re-solidify. Once the plastic has re-solidified, the pressure within the resurfacing tool 910 can be released by removing fluid from within the resurfacing tool 910. This causes the resurfacing tool 910 to deflate, allowing it to be withdrawn from the part 1000 through one of the openings 1006.

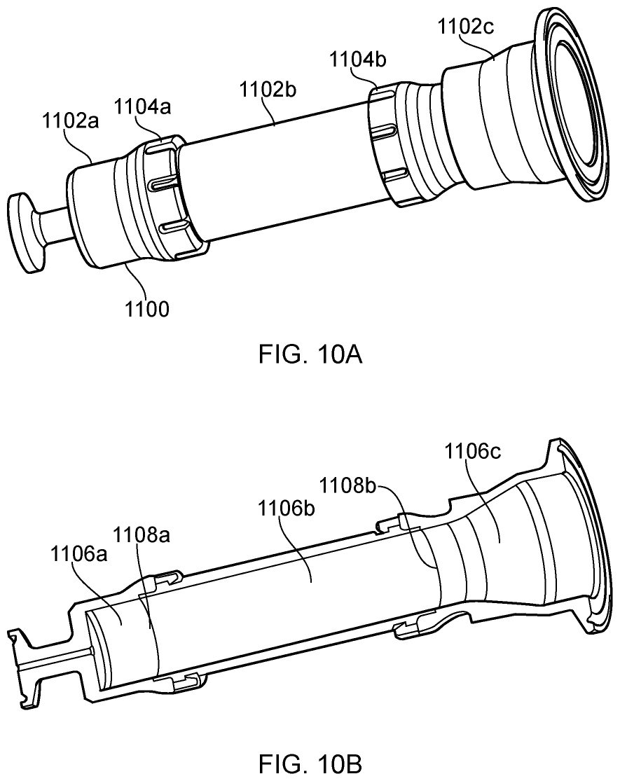

The implementations described above can also be used to join 3D printed parts together. For example, parts that are difficult to produce as a single unit using 3D printing may be produced in multiple pieces and subsequently joined together using the surface heat treatment methods described above. An example of a part 1100 comprising multiple 3D printed component parts 1102 is shown in FIGS. 10A and 10B.

Specifically, FIG. 10A shows a part 1100 comprising a first 3D printed component part 1102a, a second 3D printed component part 1102b, and a third 3D printed component part 1102c. The first component part 1102a is joined to the second component part 1102b by a first snap fit attachment 1104a. The third component part 1102c is joined to the second component part 1102b by a second snap fit attachment 1104b. The snap fit attachments 1104 allow the component parts 1102 to be held together while the internal surfaces of the component parts 1102 are heat treated.

FIG. 10B shows the internal surfaces 1106 of the component parts 1102 (in particular, a first internal surface 1106a of the first component part 1102a, a second internal surface 1106b of the second component part 1102b, and a third internal surface 1106c of the third component part 1102c).

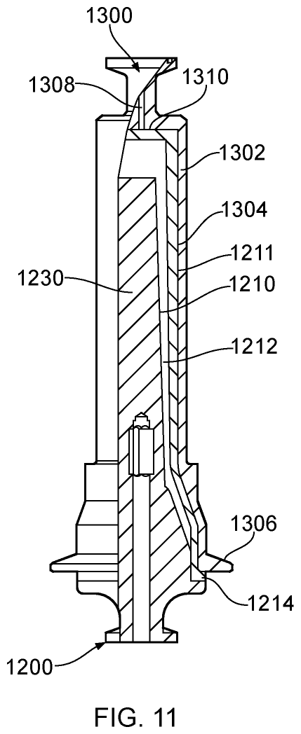

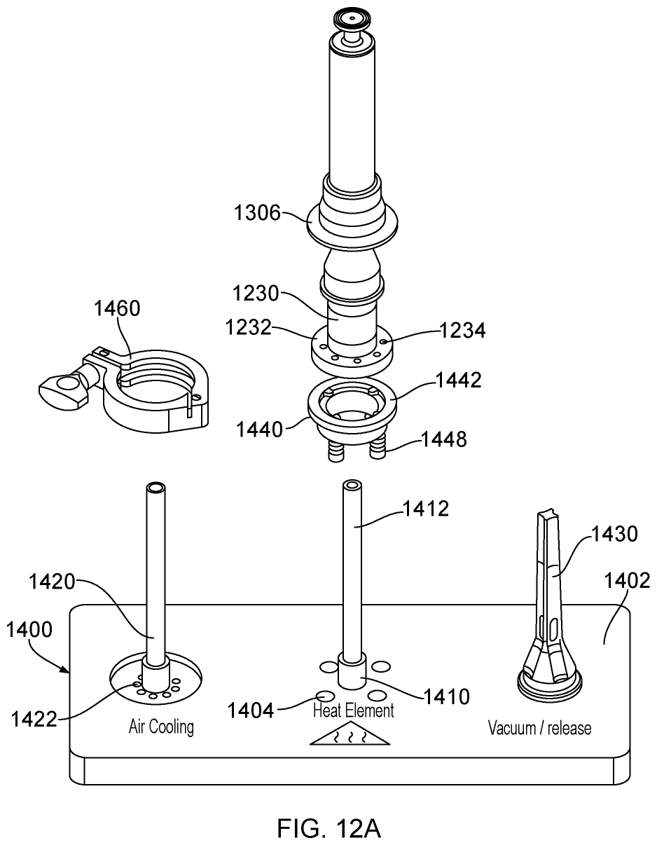

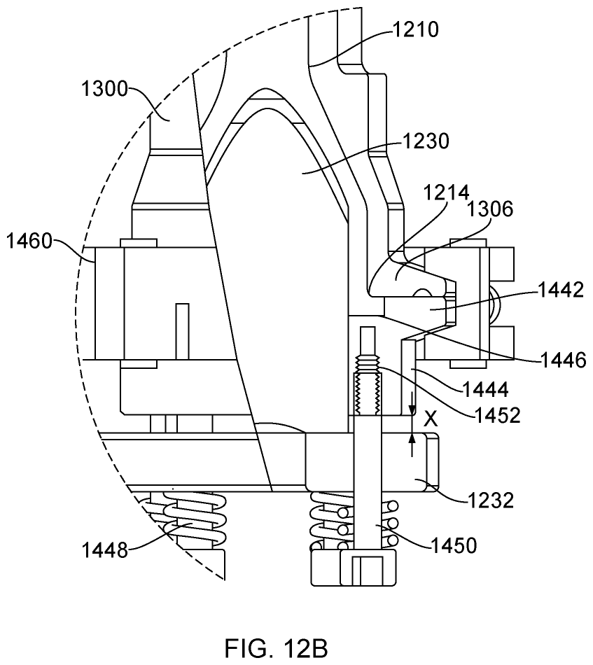

The internal surfaces 1106 of the component parts 1102 can be heat treated in the same way as the surfaces of the 3D printed part 800 shown in FIG. 8A. and the 3D printed part 1000 shown in FIGS. 9A and 9B. In particular, individual internal surfaces 1106 of the component parts 1102 can be treated using an elastomeric (e.g. silicone) resurfacing tool having a contact surface that conforms to the internal surfaces when pressure is applied using a fluid that is pumped into the resurfacing tool. In addition, heat can be applied via the resurfacing tool to a first join 1108a between the internal surfaces 1106a and 1106b and to a second join 1108b between the internal surfaces 1106b and 1106c. In this way, the plastic material of the individual component parts 1102 can be melted in order to join the individual component parts 1102 together, thereby forming the part 1100. In one example, a vacuum can be applied to the exterior surfaces of the component parts 1102, in order to draw the molten plastic through the joins 1108 between the component parts 1102. FIG. 11 shows a partial cross-sectional view through components of a seventh apparatus 1200 for surface treatment of a sixth 3D printed part 1300. The apparatus 1200 further comprises a processing station 1400, shown in FIG. 12A. In the example shown in FIGS. 11, 12A and 12B, the 3D printed part 1300 is a column such as a chromatography column. The 3D printed part 1300 comprises a substantially cylindrical cavity 1302, having an internal surface 1304 that is to be treated. The 3D printed part 1300 also includes a flange 1306 at an open end of the cavity 1302. The opposite end of the cavity 1302 comprises an end surface 1310 having a small through-hole 1308 that provides a fluidic connection between the cavity 1302 and the exterior of the part 1300.

The apparatus 1200 comprises an elastomeric (e.g. silicone) resurfacing tool 1210 having a contact surface 1211 that is arranged to contact the surface 1304 of the 3D printed part 1300. In particular, the resurfacing tool 1210 is configured to fit within the cavity 1302, as best shown in FIG. 11. Referring still to FIG. 11, it can be seen that the resurfacing tool 1210 itself comprises a cavity 1212. As shown in the example of FIG. 11, the cavity 1212 of the resurfacing tool 1210 allows the resurfacing tool 1210 to be mounted on a vacuum station 1430 of the processing station 1400, which is described further below with reference to FIG. 12A.

The cavity 1212 of the resurfacing tool 1210 is also arranged to receive, at a subsequent stage of the surface heat treatment process, a tool support 1230 that supports the resurfacing tool 1210 and allows heat and pressure to be transferred to the resurfacing tool 1210. The receipt of the tool support 1230 within the cavity 1212 of the resurfacing tool 1210 is shown schematically in FIG. 12A.

Returning to FIG. 11, it can be seen that the resurfacing tool 1210 also comprises a flange 1214 configured to contact the flange 1306 of the part 1300 when the resurfacing tool 1210 is fully inserted into the cavity 1302.

As shown in FIG. 12A, the tool support 1230 also comprises a flange 1232 provided on a portion of the tool support 1230 that protrudes from the cavity 1212 of the resurfacing tool 1210 when the tool support 1230 is inserted into the resurfacing tool 1210. The flange 1232 of the tool support 1230 comprises a plurality of through-holes 1234, described further below. In addition, the tool support 1230 has its own cavity (not visible in FIG. 12A) that allows the tool support 1230 to be mounted on a heating station 1410 of the processing station 1400 and, separately, on an air cooling station 1420 of the processing station 1400 (each described further below).

As shown in FIG. 12A, the processing station 1400 comprises a base 1402 on which the heating station 1410, the air cooling station 1420, and the vacuum station 1430 are supported.

The apparatus 1200 further comprises a clamping support 1440 having a flange 1442 disposed at one end of an annular body 1444 of the clamping support 1440. The flange 1442 is configured to contact the flange 1306 of the 3D printed part 1300 (as shown in the section view of FIG. 12B). A clamp 1460 is arranged to fit around the flange 1442 of the clamping support 1440 and the flange 1306 of the part 1300, in order to removably attach the part 1300 to the clamping support 1440. An annular recess 1446 at the inner shoulder of the flange 1442 accommodates the flange 1214 of the resurfacing tool 1210 when the clamping support 1440 is clamped to the part 1300.

FIGS. 12A and 12B show that the clamping support 1440 comprises a plurality of springs 1448. The springs 1448 are arranged to fit within corresponding apertures 1404 in the base 1402 of the processing station 1400. Each of the springs 1448 is attached to an end of the annular body 1444 that is opposite to the end at which the flange 1442 is disposed. Each spring 1448 is attached to the annular body 1444 using a corresponding screw 1450, one of which is shown in FIG. 12B. Each screw 1450 is received in a corresponding threaded hole 1452 in the annular body 1444. Rotation of the screws 1450 allows the distance between the protruding ends of the springs 1448 and the annular body 1444 to be adjusted.

In order to attach the clamping support 1440 to the tool support 1230, the screws 1450 are firstly removed from their corresponding threaded holes 1452, which removes the corresponding springs 1448 from attachment to the annular body 1444. Each screw 1450 is then inserted through a corresponding through-hole 1234 in the flange 1232 of the tool support 1230 from a first side of the flange 1232 (e.g. an underside of the flange 1232, as shown in FIG. 12B).

Each screw 1450 is then screwed into a corresponding threaded hole 1452 in the annular body 1444, which is positioned on a second side of the flange 1232 (e.g. a topside of the flange 1232, as shown in FIG. 12B). The insertion of the screws 1450 into the threaded holes 1452 compresses the springs 1448 against the flange 1232 of the tool support 1230, thereby applying a force to the tool support 1230 (and, consequently, to the resurfacing tool 1210). Rotation of the screws 1450 within the threaded holes 1452 adjusts the compression of the springs 1448 against the flange 1232, allowing the force applied to the surface 1304 by the contact surface 1211 of the resurfacing tool 1210 to be adjusted. In particular, the distance between the flange 1232 of the tool support 1230 and the annular body 1444 of the clamping support 1440 (indicated as ‘X’ in FIG. 12B) determines the spring force acting on the tool support 1230, and, in turn, the resurfacing tool 1210. Once the part 1300 is clamped to the clamping support 1440 using the clamp 1460, the force applied to the tool support 1230 by the springs 1448 results in pressure being applied to the surface 1304 of the part 1300 by the contact surface 1211 of the resurfacing tool 1210.

As shown in FIG. 12A, the base 1402 of the processing station 1400 further comprises a plurality of air conduits 1422 arranged in an annular pattern around the base of the air cooling station 1420. For example, the clamped assembly shown in FIG. 12B can be removed from the heating station 1410 and placed on the air cooling station 1422. Air can then be supplied into the cavity of the tool support 1230 via the plurality of air conduits 1422.

The vacuum station 1430 is configured to provide a vacuum to collapse the resurfacing tool 1210 so that it can be inserted into the cavity 1302 of the part 1300. The vacuum station 1430 prevents the resurfacing tool 1210 from collapsing to a flat shape (which could occur if a vacuum were simply applied to one end of the resurfacing tool 1210, resulting in interior surfaces of the resurfacing tool 1210 becoming stuck together). Applying a vacuum to the resurfacing tool 1210 pulls the walls of the resurfacing tool 1210 radially inwards, which ensures that the surfaces of the resurfacing tool 1210 do not stick to the interior surfaces of the cavity 1302 during insertion of the resurfacing tool 1210 into the cavity 1302. Once the vacuum has been applied to the resurfacing tool 1210, the part 1300 can be placed over the resurfacing tool 1210 so that the resurfacing tool 1210 is received in the cavity 1302 of the part 1300. Once the resurfacing tool 1210 has been fully inserted into the cavity 1302, the resurfacing tool 1210 and part 1300 can be removed from the vacuum station 1430, so that the tool support 1230 can be inserted into the cavity 1212 of the resurfacing tool 1210.

The vacuum provided by the vacuum station 1430 also allows the resurfacing tool 1210 to be collapsed following re-solidification of the molten plastic of the surface 1304. In particular, the vacuum pulls the contact surface 1211 away from the surface 1304, thereby allowing the resurfacing tool 1210 to be removed from the cavity 1302 of the part 1300.

In use, the resurfacing tool 1210 is initially mounted on the vacuum station 1430. A vacuum is applied in order to collapse the resurfacing tool 1210. Once collapsed, the part 1300 is mounted on the resurfacing tool 1210 by positioning the cavity 1302 over the resurfacing tool 1210. A vacuum is applied to the through-hole 1308 of the part 1300 using a vacuum line (not shown) from a control cabinet. The vacuum applied by the vacuum station 1430 is then released, allowing the resurfacing tool 1210 to expand to the interior surfaces of the cavity 1302. The vacuum applied to the through-hole 1308 prevents the formation of air pockets as the resurfacing tool 1210 expands.

The resurfacing tool 1210 and part 1300 are then removed from the vacuum station 1430 and the tool support 1230 is inserted into the cavity 1212 in the resurfacing tool 1210. The clamping support 1440 is attached to the flange 1232 of the tool support 1230 by inserting the screws 1450 of the clamping support 1440 through the through-holes 1234 in the flange 1232 and into the threaded holes 1452 in the annular body 1444 of the clamping support 1440. The screws 1450 are tightened in order to compress the springs 1448 of the clamping support 1440 against the flange of the tool support 1232.

The clamp 1460 is then secured around the flange 1306 of the part 1300 and the flange 1442 of the clamping support 1440. Clamping the flanges 1306, 1442 together results in pressure being applied to the surface 1304 by the contact surface 1211 of the resurfacing tool 1210, as a result of the compressive force exerted by the springs 1448 on the tool support 1230.

The clamped assembly is then positioned on the heating station 1410, so that the springs 1448 are located within the apertures 1404. Heat is subsequently applied to the surface 1304. In this example, the heat is applied by activating a heating element of the heating station 1410. The heating element applies heat to the tool support 1230, which transfers heat to the contact surface 1211 of the resurfacing tool 1210 by conduction. The surface 1304 is heated well above the melting temperature of the 3D printed part 1300.

Once the surface 1304 has been treated, the clamped assembly is removed from the heating station 1410 and placed on the air cooling station 1420. The clamp 1460 is not removed at this stage, in order to ensure that pressure continues to be applied to the surface 1304 during cooling. This allows the surface 1304 to re-solidify prior to removal of the resurfacing tool 1210, which avoids the resurfacing tool 1210 becoming adhered to the surface 1304. The surface 1304 is then cooled prior to removal of the resurfacing tool 1210. In order to cool the surface 1304, air can be supplied to the interior of the tool support 1230 via the air conduits 1422 in the base 1402 of the processing station 1400. The cooled air supplied to the tool support 1230 in turn cools the contact surface 1211 of the resurfacing tool 1210. This lowers the temperature of the surface 1304 below the melt temperature of the material of the 3D printed part 1300, causing solidification of the material.

Once the surface 1304 has re-solidified, the clamp 1460 is removed, which allows the tool support 1230 to be removed from the cavity 1212 of the resurfacing tool 1210. Once the tool support 1230 has been removed, the resurfacing tool 1210 and part 1300 can be placed on the vacuum station 1430, which applies a vacuum to pull the contact surface 1211 away from the surface of the part 1304. The part 1300 can then be removed from the resurfacing tool 1210.

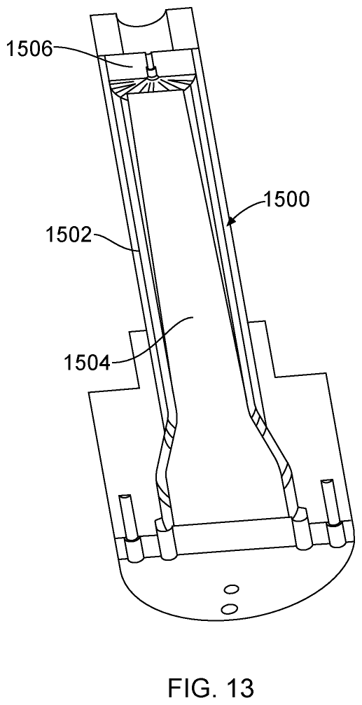

FIG. 13 is a perspective view of a mould 1500 that may be used to manufacture the resurfacing tool 1210 shown in FIGS. 11, 12A and 12B. The resurfacing tool 1210 may be formed of 1-component silicone or 2-component silicone. These materials have different properties and can be used at different temperatures, thereby allowing a wide range of materials to be heat treated.

The mould 1500 has an interior surface 1502 that corresponds to the contact surface 1211 of the resurfacing tool 1210. The interior surface 1502 therefore has a high gloss finish with low surface roughness. The mould 1500 also has a core 1504, which can be removed after moulding the resurfacing tool 1210, in order to provide the cavity 1212 in the resurfacing tool 1210. The material of the core 1504 may be capable of binding gases from the silicone used to form the resurfacing tool 1210, when using 1-component silicone. For more complex geometries, the core may be a sacrificial core that is melted away following formation of the resurfacing tool, in which case the core has a melting temperature that is lower than the melting temperature of silicone.

The mould 1500 further comprises an end plug 1506, which may have a patterned surface in order to impart a patterned surface to the end of the resurfacing tool 1210. Accordingly, the patterned surface may, in turn, be imparted to the part 1300 during heat treatment of the part 1300. For example, a fluid distribution or collection pattern may be imparted to the end surface 1310 of the cavity 1302 (which, when the part 1300 is in use, is the bottom of the column), in order to encourage fluid to flow towards the through-hole 1308.

Once the resurfacing tool 1210 has been moulded, the contact surface 1211 is polished in order to provide a high gloss surface with low surface roughness. For example, the contact surface 1211 may be polished so that it has a mean surface roughness Ra value of less than about 2 to about 2.4 μm. For example, a mean Ra value may preferably be less than 1 μm, in order to provide a surface finish of the surface 210 that is suitable for use as a sealing surface. More preferably, a mean Ra may be less than 0.4 μm, such as in the range of about 0.2-0.4 μm. During heat treatment of a surface, the surface roughness of the contact surface 1211 is transferred to the surface being treated.

As explained above, the contact surface of the resurfacing tool has the negative shape of the desired finish of the surface, and preferably has a high gloss surface, thereby minimising surface roughness. In other embodiments, an elastomeric resurfacing tool can be used to imprint text, patterns, scales, and other local features on a surface that is to be treated. Such local features can be imprinted on exterior or interior surfaces of 3D printed parts. In addition, such local features can be imprinted on interior surfaces using a resurfacing tool that expands within the 3D printed part (e.g. as described with reference to FIGS. 8A, 8B and 9).

In general, however, the part is manufactured so as to be as close as possible to the intended final surface. This allows the surface to be treated, without having to provide waste sections for collecting excess molten material resulting from heat treatment of the surface (which would be required, for example, if the geometry of the surface were being changed). The embodiments described above can, however, be used for changing the geometry of a surface, provided that the part and/or resurfacing tool is configured to permit molten material to flow to a region where the surface is sealed against the ambient environment. For example, in the arrangement shown in FIGS. 5 to 7, the geometry of the surfaces 620 could be changed by allowing excess molten material to flow to the open end of the port 606a, to allow it to re-solidify.

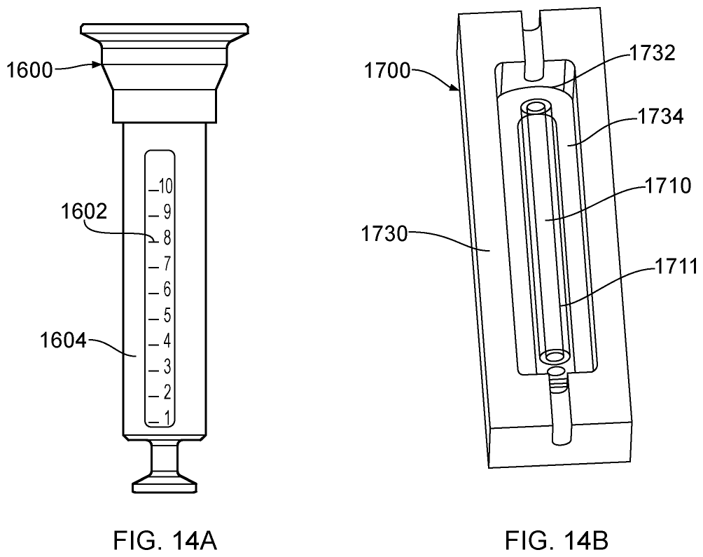

FIG. 14A shows a seventh 3D printed part 1600 having local features in the form of a scale 1602 imprinted on an exterior surface 1604 of the part 1600. FIG. 14B shows an eighth apparatus 1700 for surface treatment of the 3D printed part 1600. In particular, the apparatus 1700 is used for imprinting the scale 1602 onto the 3D printed part 1600 shown in FIG. 14A. As shown in FIG. 14B, the apparatus 1700 comprises a tool support 1730 having a convex inner surface 1732 configured for placement against the convex exterior surface 1604 of the part 1600.

The apparatus 1700 further comprises an elastomeric (e.g. silicone) resurfacing tool 1710 housed within a cavity 1734 of the tool support 1730. The resurfacing tool 1710 has a patterned contact surface 1711 which is the negative of the scale 1602 that is to be imprinted on the part 1600. Mechanical pressure can be applied to the resurfacing tool 1710 the cavity 1734 so that pressure is applied to the contact surface 1711. Heated fluid can then be pumped into the resurfacing tool 1710 in order to melt the surface 1604 such that the molten plastic conforms to the patterned contact surface 1711. Cooled fluid is then pumped in to the resurfacing tool 1710 in order to cause the surface 1604 to re-solidify, prior to deflation of the resurfacing tool 1710 to release the mechanical pressure on the surface 1604. A metal backing (not shown) to the resurfacing tool 1710 can, in one example, prevent inflation of the resurfacing tool 1710 when heated or cooled fluid is pumped into the resurfacing tool 1710. Alternatively, heat can be applied to the resurfacing tool 1710 using a heating element.

In some examples, the resurfacing tool 1710 can also be used to melt the surface 1604 so that it becomes more transparent, in which case the scale 1602 can be seen from the exterior of the part 1600.

As another example, a dimpled pattern may be applied to an interior surface of a 3D printed part. Such patterned features could, for example, be used to initiate liquid motion in a desired way, or to create turbulence within a liquid flow.

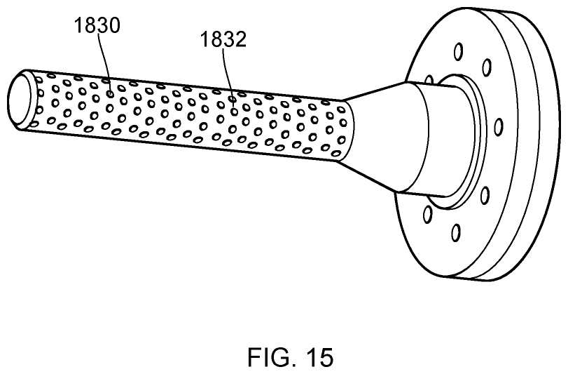

FIG. 15 shows an alternative tool support 1830 that may be used in place of the tool support 1230 shown in FIGS. 11, 12A and 12B. The tool support 1830 comprises a plurality of domed protrusions 1832 on the surface that contacts the interior surfaces of the cavity 1212 of the resurfacing tool 1210.

The domed protrusions 1832 apply a radially outward force to the interior surfaces of the cavity 1212 when the tool support 1830 is inserted into the cavity 1212, thereby allowing pressure to be applied to a surface to be treated using the resurfacing tool 1210. However, the domed protrusions 1832 result in a much smaller contact area between the tool support 1830 and the interior surfaces of the cavity 1212 than in the arrangement shown in FIGS. 11, 12A and 12B. The smaller contact area reduces the friction between the tool support 1830 and the resurfacing tool 1210, when compared with the tool support 1230. This allows the tool support 1830 to be more easily inserted into and removed from the cavity 1212, when compared with the tool support 1230.

In addition, the tool support 1230 has a generally conic shape, with a steep angle (i.e. close to a cylinder), which can be appreciated from the profile of the resurfacing tool mould shown in FIG. 13. The angular tolerance of the steep angle of the conic shape has a large effect on the extent to which the tool support 1230 can be inserted into the cavity 1212. In contrast, the domed protrusions 1832 on the tool support 1830 reduce the effect of the angular tolerance of the steep angle on the extent to which the tool support 1230 can be inserted into the cavity 1212. This is because the elastomeric material of the resurfacing tool 1210 can be displaced into the voids between the domed protrusions 1830.

The domed protrusions could alternatively be provided on interior surfaces of the cavity 1212 of the resurfacing tool 1210. When such a resurfacing tool 1210 is used in conjunction with a tool support 1230 having a conic shape (e.g. as shown in FIGS. 12A and 12B), the same benefits concerning insertion of the tool support 1230 and reduced effect of angular tolerance can be achieved.

It will be appreciated that other elastomeric materials may be used for surface treatment of 3D printed parts. Silicone is a particularly preferred material for the resurfacing tool, as a result of its high heat resistance and its compatibility with oils (which may be used to apply heat and/or pressure to the contact surface of the resurfacing tool), meaning that it has a long life expectancy. Silicone resurfacing tools can be manufactured inexpensively and easily, and provide a surface finish at least as good as that achieved using metal surface processing tools. The ability to deform silicone resurfacing tools means that they can be used for surface treatment of complex surfaces. In particular, a silicone resurfacing tool is better suited for alignment with a surface to be treated than, for example, a metal tool, because the silicone resurfacing tool can adapt to tolerance deviations in the surface to be treated.

In one or more examples, the resurfacing tool can include a number of sensors. The sensors may form part of a control system for controlling the heat treatment of the surface of the 3D printed part. For example, temperature sensors may be embedded in the material of the resurfacing tool, close to the contact surface. The temperature sensors may be used as part of a control system comprising a programmable logic controller (PLC), in order to ensure that the contact surface is heated to the temperature required to melt the surface of the 3D printed part. Additional sensors can include: flow meters, for measuring the flow rates of air (e.g. for supplying air to an inflatable void within the resurfacing tool) or oil (for applying heat and/or pressure to the contact surface of the resurfacing tool); pressure sensors, for measuring the pressure applied to the contact surface; and position sensors, for determining the placement of the contact surface relative to the surface that is to be treated. Such sensors can be used to provide feedback to a PLC system for adjustment of parameters relating to the surface treatment.

### Example 1

A 3D printed tri-clamp component (identical to the part 200 shown in FIGS. 2A to 3C) was subjected to the surface treatment method 1900 described above at its annular top surface (i.e. the surface 210 shown in FIGS. 2A to 3C), using the apparatus 190 shown in FIGS. 3A to 3C. Prior to surface treatment, the annular top surface had a surface roughness value of around 14 to 20 μm.

Surface roughness measurements were taken at two points on the annular top surface, using a confocal laser microscope. Laser scanning was used to obtain the profile data used for computation of the surface roughness values. At the first measurement location, an areal roughness (Sa) value of 0.369 μm and a profile roughness (Ra) value of 0.289 μm were measured. At the second measurement location, a Sa value of 0.406 μm and a Ra value of 0.359 μm were measured.

Accordingly, a surface roughness value of less than 0.4 μm was achieved using the surface treatment method 1900 on the flat annular surface of the 3D printed tri-clamp component.

### Example 2

A 3D printed column (identical to the column shown in FIGS. 11, 12A and 12B) was subjected to the surface treatment method 1900 described above at its curved inner surface (i.e. the surface 1304 shown in FIG. 11), using the apparatus 1200 shown in FIGS. 11, 12A and 12B. Prior to surface treatment, a reference measurement on the untreated surface yielded a surface roughness value of 17.28 μm.

Surface roughness measurements were taken at four points on the curved inner surface, in the same manner as for Example 1. At the first measurement location, a surface roughness value of 0.829 was measured. At the second measurement location, a surface roughness value of 0.824 was measured. At the third measurement location, a surface roughness value of 0.835 was measured. At the fourth measurement location, a surface roughness value of 0.924 was measured.

Accordingly, surface roughness values of less than 1 μm were consistently achieved using the surface treatment method 1900 on the curved inner surface of the 3D printed column. Very similar results were achieved when using the alternative tool support 1830 shown in FIG. 15 with the other components of the apparatus 1200 to treat the curved inner surface of a 3D printed column.

Although the implementations described above are concerned with surface treatment of specific surfaces, the invention is not limited to such surfaces. In particular, the teachings of the present invention may be applied to any surface, either internal to a 3D printed bioprocessing part or external to a 3D printed bioprocessing part. In such cases, the shape and configuration of the resurfacing tool and supporting components may be adapted to the surface being treated. In various embodiments, for example, the resurfacing tool may comprise a moulded flexible layer with one or more variation in thickness to achieve different properties in different areas, e.g. with thinner portions to conduct heat or thicker portions to insulate more. Moreover, as mentioned above, the implementations described herein are not limited to the surface treatment of 3D printed bioprocessing parts and can be applied to the treatment of surfaces (both internal and external) of 3D printed parts in general. Furthermore, the implementations described herein can be used to repair parts (for example, without the need to add further material(s) such as prepreg fiber reinforced matts, liquid resins, etc. or to cure with UV light, etc.). To repair parts, a resurfacing tool can be created and then pressed against the damaged parts. Heat, or heat and plastic material, could then be added in order to repair the damaged portion of the part.

Various embodiments of the present invention provide a moulded/shaped design for a flexible tool with high dimensional accuracy which is then replicated in a final treated article. The flexible tool may be produced from either an initially smooth or rough surfaced (e.g. sheet) material (which can subsequently be flattened), with surface and/or thickness features being appropriately positioned to correspond to desired features/regions in the final treated article. One or more temperature sensors may also be included which can locally and accurately measure actual temperature(s) at one or more desired locations.

It will be appreciated that specific features of the apparatus embodiments described herein (such as the inflatable channels 118, 122 of the apparatus 100 and apparatus 190, the inflatable void 516 of the apparatus 500, and the clamping components of the apparatus 1200, among others) are not limited to such embodiments and may be incorporated into other embodiments described herein. For example, one or more of the described embodiments may be modified to include inflatable channels in order to apply pressure to the surface to be treated of the 3D printed part via the contact surface of the resurfacing tool, or to include an inflatable void to provide sealing against ingress of molten plastic into sensitive internal regions of the 3D printed part.

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

Bioprocessing equipment could be but not limited to, for example, a chromatography system, a filtration system, an aseptic filling system, a fermentation system, a bioreactor assembly or a mixer assembly. In one or more embodiments of the invention, the apparatus is operable manually or is semi-automated or full automated. The apparatus of the invention could be used as a standalone apparatus or be part of an assembly line. In one or more embodiments of the invention, the method for surface treatment could be performed manually, semi-automatically or fully automatically. The method of the invention could be performed using a PLC based control unit by using one or more closed feedback loops to control the various process parameters. The method of the invention could also be performed using an open loop configuration. The apparatus of the invention can be used to treat a variety of 3D printed parts by adapting the resurfacing tool to the shape of the surface to be treated. The control unit may be a computing device, a semiconductor-based microprocessor, a central processing unit (CPU), an application specific integrated circuit (ASIC), and/or other hardware processing device. The controller may be a separate component or may be integrated with the apparatus.

1. A method (1900) for surface treatment of 3D printed parts for bioprocessing equipment, the method comprising:
applying (1902) pressure to a surface (210, 402, 620, 804, 1008, 1304, 1604) to be treated of a 3D printed part (200, 400, 600, 800, 1000, 1100, 1300, 1600) using a contact surface (111, 311, 511, 711, 911, 1211, 1711) of an elastomeric resurfacing tool (110, 310, 510, 710, 910, 1210, 1710);
heating (1904) the contact surface (111, 311, 511, 711, 911, 1211, 1711) to a temperature above the melting temperature of a material of the 3D printed part (200, 400, 600, 800, 1000, 1100, 1300, 1600), thereby melting the surface (210, 402, 620, 804, 1008, 1304, 1604) to form a molten layer of the material at the surface (210, 402, 620, 804, 1008, 1304, 1604);
allowing (1906) the surface (210, 402, 620, 804, 1008, 1304, 1604) to cool such that the molten layer formed at the surface (210, 402, 620, 804, 1008, 1304, 1604) re-solidifies, thereby producing a treated surface; and
withdrawing (1908) the pressure applied to the treated surface.

2. The method of claim 1, wherein applying (1902) the pressure to the surface (210, 402, 620, 804, 1008, 1304, 1604) comprises pressurising a fluid within the resurfacing tool (110, 310, 510, 710, 910, 1210, 1710).

3. The method of claim 2, wherein pressurising the fluid within the resurfacing tool (110, 310, 510, 710, 910, 1210, 1710) comprises pressurising the fluid to deform the resurfacing tool such that the contact surface (111, 311, 511, 711, 911, 1211, 1711) of the resurfacing tool (110, 310, 510, 710, 910, 1210, 1710) is forced into contact with the surface (210, 402, 620, 804, 1008, 1304, 1604).

4. The method of claim 2 or claim 3, wherein withdrawing (1908) the pressure applied to the treated surface comprises reducing the pressure applied to the fluid within the resurfacing tool (110, 310, 510, 710, 910, 1210, 1710).

5. The method of any of claims 1 to 4, wherein heating (1904) the contact surface (111, 311, 511, 711, 911, 1211, 1711) of the resurfacing tool (110, 310, 510, 710, 910, 1210, 1710) comprises activating a heating element (150, 350, 550) to apply heat to the contact surface (111, 311, 511, 711, 911, 1211, 1711).

6. The method of any of claims 1 to 5, wherein heating (1904) the contact surface (111, 311, 511, 711, 911, 1211, 1711) of the resurfacing tool (110, 310, 510, 710, 910, 1210, 1710) comprises supplying a heated fluid to apply heat to the contact surface (111, 311, 511, 711, 911, 1211, 1711).

7. The method of any of claims 1 to 6, wherein heating (1904) the contact surface (111, 311, 511, 711, 911, 1211, 1711) of the resurfacing tool (110, 310, 510, 710, 910, 1210, 1710) comprises heating a first region of the resurfacing tool (110, 310, 510, 710, 910, 1210, 1710) that comprises the contact surface (111, 311, 511, 711, 911, 1211, 1711), without heating a second region of the resurfacing tool (110, 310, 510, 710, 910, 1210, 1710) that contacts a different surface of the 3D printed part (200, 400, 600, 800, 1000, 1100, 1300, 1600).

8. The method of any of claims 1 to 7, wherein allowing (1906) the surface (210, 402, 620, 804, 1008, 1304, 1604) to cool comprises actively cooling the contact surface (111, 311, 511, 711, 911, 1211, 1711), optionally wherein actively cooling the contact surface (111, 311, 511, 711, 911, 1211, 1711) comprises supplying a fluid to cool the contact surface (111, 311, 511, 711, 911, 1211, 1711).

9. The method of any of claims 1 to 8, further comprising supplying fluid to an inflatable void (516) within the resurfacing tool (110, 310, 510, 710, 910, 1210, 1710), to inflate a portion of the resurfacing tool (110, 310, 510, 710, 910, 1210, 1710) and form a seal between the portion of the resurfacing tool (110, 310, 510, 710, 910, 1210, 1710) and the 3D printed part (200, 400, 600, 800, 1000, 1100, 1300, 1600).

10. The method of any of claims 1 to 9, wherein the resurfacing tool (110, 310, 510, 710, 910, 1210, 1710) is formed of silicone.

11. An apparatus (100, 190, 300, 500, 700, 900, 1200, 1700) for surface treatment of 3D printed parts for bioprocessing equipment, the apparatus (100, 190, 300, 500, 700, 900, 1200, 1700) comprising:
an elastomeric resurfacing tool (110, 310, 510, 710, 910, 1210, 1710) comprising a contact surface (111, 311, 511, 711, 911, 1211, 1711), wherein the contact surface (111, 311, 511, 711, 911, 1211, 1711) comprises a negative shape of a surface (210, 402, 620, 804, 1008, 1304, 1604) to be treated of a 3D printed part (200, 400, 600, 800, 1000, 1100, 1300, 1600);
a pressure source configured to apply pressure to the surface (210, 402, 620, 804, 1008, 1304, 1604) using the contact surface (111, 311, 511, 711, 911, 1211, 1711); and
a heat source configured to apply heat to the contact surface (111, 311, 511, 711, 911, 1211, 1711).

12. The apparatus of claim 11, wherein the heat source comprises an activatable heating element (150, 350, 550); and/or wherein the heat source comprises a pump (752) configured to supply heated fluid to the apparatus (100, 190, 300, 500, 700, 900, 1200, 1700).

13. The apparatus of claim 11 or claim 12, wherein the pressure source comprises a clamp (342, 1460) configured to apply mechanical pressure to the surface (210, 402, 620, 804, 1008, 1304, 1604) using the contact surface (111, 311, 511, 711, 911, 1211, 1711).

14. The apparatus of any of claims 11 to 13, wherein the pressure source comprises a pump (752, 762) configured to pressurise a fluid within the resurfacing tool (110, 310, 510, 710, 910, 1210, 1710).

15. The apparatus of any of claims 11 to 14, further comprising a cooling source configured to cool the contact surface (111, 311, 511, 711, 911, 1211, 1711).

16. The apparatus of claim 15, wherein the cooling source comprises a pump (762) configured to supply fluid to cool the contact surface (111, 311, 511, 711, 911, 1211, 1711).

17. The apparatus of any of claims 11 to 16, wherein the resurfacing tool (110, 310, 510, 710, 910, 1210, 1710) comprises a first region that comprises the contact surface (111, 311, 511, 711, 911, 1211, 1711), and a second region, wherein a wall thickness of the second region of the resurfacing tool (110, 310, 510, 710, 910, 1210, 1710) is greater than a wall thickness of the first region of the resurfacing tool (110, 310, 510, 710, 910, 1210, 1710).

18. The apparatus of any of claims 11 to 17, wherein the resurfacing tool (110, 310, 510, 710, 910, 1210, 1710) comprises an inflatable void (516).

19. The apparatus of any of claims 11 to 18, wherein the resurfacing tool (110, 310, 510, 710, 910, 1210, 1710) is formed of silicone.

20. The apparatus of any of claims 11 to 19, wherein the pressure source comprises a pump configured to supply fluid to one or more inflatable portions (118, 122) of the resurfacing tool (110, 310, 510, 710, 910, 1210, 1710), thereby causing the contact surface (111, 311, 511, 711, 911, 1211, 1711) to be clamped against the surface (210, 402, 620, 804, 1008, 1304, 1604).

21. The apparatus of any of claims 11 to 20, wherein the contact surface (111, 311, 511, 711, 911, 1211, 1711) comprises a patterned or textured profile.

22. A 3D printed part (200, 400, 600, 800, 1000, 1100, 1300, 1600) for bioprocessing equipment, comprising at least a partial surface portion thereof having a mean surface roughness value Ra (μm) that is: less than about 16 μm; less than about 15, 14, 13, 12, 11, 10, 9, 8, 7, 6, 5, 4, 3, 2.4, 2, 1.6, 1.5, 1, 0.9, 0.8, 0.7, 0.6, 0.5 or 0.4 μm; about 0.4 μm; from about 0.2, 0.3, 0.4, 0.5 or 0.6 μm to about 0.3, 0.4, 0.5, 0.6, 0.7, 0.8 or 0.9 μm; from about 0.2 or 0.3 to about 0.4 μm; and/or in the range from about 0.1, 0.2, 0.3, 0.4, 0.5, 0.6, 0.7, 0.8 or 0.9 μm to about 15, 14, 13, 12, 11, 10, 9, 8, 7, 6, 5, 4, 3, 2.4, 2, 1.6, 1.5, 1, 0.9, 0.8, 0.7, 0.6, 0.5 or 0.4 μm.

23. The 3D printed part (200, 400, 600, 800, 1000, 1100, 1300, 1600) of claim 22, a material of said part (200, 400, 600, 800, 1000, 1100, 1300, 1600) comprises one or more of: thermoplastics material, nylon, polypropylene (PP), polyethylene (PE) and/or cyclic olefin copolymer (COC) polymer.

24. The 3D printed part (200, 400, 600, 800, 1000, 1100, 1300, 1600) of claim 22 or claim 23, comprising a surface treated layer having a depth in the range of less than about 10, 15, 20, 30, 40 or 50 μm, from about 0.1-10.0 μm, in the range of about 4.0-9.0 μm and/or in the range of about 6.0-8.0 μm.

25. The 3D printed part (200, 400, 600, 800, 1000, 1100, 1300, 1600) of any of claims 22 to 24, wherein the partial surface portion comprises a surface that is not accessible in a linear motion from outside of the 3D printed part (200, 400, 600, 800, 1000, 1100, 1300, 1600).

26. The 3D printed part (200, 400, 600, 800, 1000, 1100, 1300, 1600) of any of claims 22 to 25, wherein the part (200, 400, 600, 800, 1000, 1100, 1300, 1600) is a composite part comprising a plurality of component parts (1102), and wherein the partial surface portion comprises a join (1108) between two or more of the plurality of component parts (1102).
